(19) United States
(12) Patent Application Publication
(10) Pub. No.: US 2026/0080373 A1
(43) Pub. Date: Mar. 19, 2026

(54) Generation and Modification of Multimodal Content Data

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/885,244

(22) Filed: Sep. 13, 2024

(51) Int. Cl. G06Q 50/00

(52) U.S. Cl. CPC G06Q 10/40

(57) ABSTRACT

Methods, systems, devices, and non-transitory computer readable media for generating or modifying features of content are provided. The disclosed technology can include receiving content data comprising content associated with one or more data multimodalities. Prompt data associated with modification of the content can be received. Contexts associated with the content data can be determined. Based on inputting the content data, the prompts, and context data based on the contexts into one or more machine-learned models, modified content data based on the content data and comprising one or more modifications of the one or more features of the content data can be generated. The one or more machine-learned models can be configured to modify the one or more features of the content data based on the one or more prompts and the context data. Furthermore, one or more content recommendations based on the modified content data can be generated.

### FIELD

The present disclosure relates generally to the generation of modified content data based on content that can be associated with various data modalities. More particularly, the present disclosure relates to the use of machine-learned models to generate modified content based on the modification of features in content that can comprise images, text, audio, or video.

### BACKGROUND

The Internet can be used to access a wide variety of content, including content in the form of images and text that are included in web pages. Further, content may be distributed, such as by directly sending the content to another user via an application (e.g., a user sending email including an image attachment to another user) or by providing the content in a web page that can be viewed by many other users. In some cases, a social media application can be used to share content that can be viewed by other users of the social media application. Those other users of the social media application can also provide their feedback and share their content with other users. However, the process of manually selecting social media content and adding information to the social media content can be time consuming and involve interaction with complex user interfaces. Accordingly, there may be different approaches to managing social media content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating modified content. The computer-implemented method can comprise receiving, by a computing system comprising one or more processors, content data comprising content associated with one or more data multimodalities. The computer-implemented method can comprise receiving, by the computing system, prompt data comprising one or more prompts associated with modification of the content data. The computer-implemented method can comprise determining, by the computing system, one or more contexts associated with the content data. The computer-implemented method can comprise generating, by the computing system, based on inputting the content data, the prompt data, and context data based on the one or more contexts into one or more machine-learned models, modified content data based on the content data and comprising one or more modifications of one or more features of the content data. The one or more machine-learned models can be configured to modify the one or more features of the content data based on the one or more prompts and the context data. Furthermore, the computer-implemented method can comprise generating, by the computing system, one or more content recommendations based on the modified content data.

Another example aspect of the present disclosure is directed to one or more tangible non-transitory computer-readable media storing computer-readable instructions that when executed by one or more processors cause the one or more processors to perform operations. The operations can comprise receiving content data comprising content associated with one or more data multimodalities. The operations can comprise receiving prompt data comprising one or more prompts associated with modification of the content data. The operations can comprise determining one or more contexts associated with the content data. The operations can comprise generating, based on inputting the content data, the prompt data, and context data based on the one or more contexts into one or more machine-learned models, modified content data based on the content data and comprising one or more modifications of one or more features of the content data. The one or more machine-learned models can be configured to modify the one or more features of the content data based on the one or more prompts and the context data. Furthermore, the operations can comprise generating one or more content recommendations based on the modified content data.

Another example aspect of the present disclosure is directed to a computing system comprising: one or more processors; one or more non-transitory computer-readable media storing instructions that when executed by the one or more processors cause the one or more processors to perform operations. The operations can comprise receiving content data comprising content associated with one or more data multimodalities. The operations can comprise receiving prompt data comprising one or more prompts associated with modification of the content data. The operations can comprise determining one or more contexts associated with the content data. The operations can comprise generating, based on inputting the content data, the prompt data, and context data based on the one or more contexts into one or more machine-learned models, modified content data based on the content data and comprising one or more modifications of one or more features of the content data. The one or more machine-learned models can be configured to modify the one or more features of the content data based on the one or more prompts and the context data. Furthermore, the operations can comprise generating one or more content recommendations based on the modified content data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can generate modified content data according to example embodiments of the present disclosure;

FIG. 1B depicts a block diagram of an example computing device that generates modified content data according to example embodiments of the present disclosure;

FIG. 1C depicts a block diagram of an example computing device that generates modified content data according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of removing personally identifiable information in content according to example embodiments of the present disclosure;

FIG. 5 depicts an example of generating video based on an image according to example embodiments of the present disclosure;

FIG. 6 depicts an example of modifying the appearance of a face in content according to example embodiments of the present disclosure;

FIG. 7 depicts an example of modifying the appearance of an object in content according to example embodiments of the present disclosure;

FIG. 8 depicts an example of modifying the size and appearance of an object in content according to example embodiments of the present disclosure;

FIG. 9 depicts an example of modifying a background of content according to example embodiments of the present disclosure;

FIG. 10 depicts an example of a link note based on modified content data according to example embodiments of the present disclosure;

FIG. 11 depicts a flow chart diagram of an example method of generating modified content data according to example embodiments of the present disclosure;

FIG. 12 depicts a flow chart diagram of an example method of generating modified content data according to example embodiments of the present disclosure; and

FIG. 13 depicts a flow chart diagram of an example method of training machine-learned models to generate modified content data according to example embodiments of the present disclosure.

Reference numerals that are repeated across plural figures are intended to identify the same features in various implementations.

### DETAILED DESCRIPTION

In general, the present disclosure is directed to generating modified content data based on the detection, recognition, and/or classification of features (e.g., visual features, audio features, and/or textual features) in content data associated with one or more data modalities (e.g., multimodal data comprising images, audio, text, and/or video). In particular, the modified content data can comprise modifications of features of content that was received. For example, based on an image of an automobile, modified content data comprising a video segment of the automobile in motion or the automobile driving through various settings can be generated. Further, the one or more content recommendations can be generated based on prompts indicating modifications to the content or the determination of one or more contexts including location information, temporal information, event information, application information (e.g., social media application contact information), and/or information associated with a user. For example, modifications to an image can reflect context associated with the preferences of the user that provided the content. Based on the modified content data, the disclosed technology can generate one or more content recommendations that can comprise different versions of the modified content data that a user can select. Further, the disclosed technology can implement machine-learned models (e.g., generative machine-learned models that can comprise transformer models and/or diffusion models) that have been configured and/or trained to generate modified content data based on the detection, recognition, and/or classification of features detected and/or recognized in content, context, or a prompt. Further, the machine-learned models can be configured and/or trained to generate modified content data by modifying one or more features of the content based on input comprising content data, context data, and/or prompt data that can comprise or be based on one or more prompts. Additionally, the modified content data can be included in one or more content recommendations that can be added to a link note that can be shared with other users and/or associated with a web resource (e.g., a social media post or a search result).

For example, a computing system can receive content data that can comprise content associated with one or more data modalities. In particular, the content can comprise images, audio segments, and/or video segments. For example, the content can comprise an image of a peacock in a nature preserve. The computing system can then determine one or more contexts associated with the content data. For example, the content data comprising the image of the peacock can comprise metadata indicating that the image is from a particular geographic location (e.g., a nature preserve in California) shown in the image. Further, the content data may be associated with an application that can be used to determine context associated with the content. For example, the application may comprise a record of images that the user viewed, which may be used to determine the types of modifications to make to content. For example, if a user views celebrity images, modifications to an image of the user may comprise modifications that are similar to features of the celebrity images the user views (e.g., hairstyle features, sartorial preferences, and/or jewelry preferences). The prompt data can be associated with the content data and can include describing a type of modification to the content such as changing the size, shape, or background of an image or video segment.). For example, the prompt data can include a prompt to increase the size of the peacock and brighten the colors of the peacocks tail feathers.

The content data which includes the image of the peacock, the context data based on the one or more contexts that were determined, and/or the prompt data can be inputted into a machine-learned model, that can generate modified content data comprising modifications of the content data (e.g., modifications of the image of the peacock). For example, the modified content data can comprise an image in which the peacock appears larger relative to its surroundings and has brighter tail feathers. Further, the colors of the background behind the peacock can be slightly toned down to emphasize the colors of the peacock. In some embodiments, different versions of the modified content data can be generated. For example, different images of the peacock with different color configurations, different sizes, and/or different backgrounds can be generated.

The one or more machine-learned models can comprise generative models that are configured and/or trained to generate the modified content data based on detection, recognition, and/or classification of features of the content data, the prompt data, and/or the context data. For example, the one or more machine-learned models can be configured and/or trained to detect and/or recognize visual features in images (e.g., recognize different portions of the peacock and the peacocks background), parse text in the prompt data, and/or determine relationships between the content data, context data, and/or prompt data.

The disclosed technology can then generate one or more content recommendations based on the modified content data. For example, content comprising an image of the peacock can be generated. In some embodiments, different versions of the modified content data can be included in the one or more recommendations. Further, the disclosed technology can generate a link note based on the one or more content recommendations. The link note can include the one or more content recommendations and a link to a web resource (e.g., a web page or social media post). For example, the link note can comprise the modified content comprising the image of the peacock, and a link to the web page from which the image was retrieved. Further, the link note can be shared with other users and/or included in a web resource. For example, the link note can be sent to one or more users in a user group of contacts associated with the user that generated the link note.

The one or more content recommendations can be used in a variety of applications including social media applications. The ability to quickly and easily generate one or more content recommendations based on modified content data can allow for more effective distribution of various types of content that can be used in a variety of applications. As such, the disclosed technology allows for improved generation of one or more content recommendations that may be used in a variety of applications including social media applications, texting applications, email applications, online forum applications, and/or various types of other communication applications.

Accordingly, the disclosed technology can automatically generate one or more content recommendations based on user content associated with various data modalities. Further, the disclosed technology can assist a user in more effectively performing the technical task of generating one or more content recommendations by means of a continued and/or guided human-machine interaction process in which content data (e.g., images, audio segments, video segments, and/or text segments) is received and one or more content recommendations are generated in real-time based on continuously updated content information, prompt information, and/or context information. For example, a user can use a computing device (e.g., a smartphone) to capture an image. The computing device can determine a context associated with the image (e.g., the time at which the image was captured) and send the image and the context data to a remote machine-learned model system that generates one or more content recommendations based on modified content data associated with the image. The remote machine-learned model can then send the one or more content recommendations back to the computing device which can be used to generate a link note based on the one or more content recommendations.

The disclosed technology can be implemented in a computing system (e.g., a content modification computing system) that is configured to access data and/or perform operations on the data. For example, the operations performed by the computing system can comprise receiving content data associated with one or more data modalities, receiving prompt data comprising one or more prompts, determining contexts associated with the content data, generating, based on inputting the content data, prompt data, and/or context data based on the one or more contexts into a machine-learned model, modified content data comprising one or more modifications of the content data, and/or generating one or more content recommendations based on the modified content data. Further, the computing system can leverage one or more machine-learned models that have been configured and/or trained to process (e.g., detect, recognize, and/or classify) content data, prompt data, and/or context data and generate modified content data based on features of the content data, prompt data, and/or context data.

The computing system can be included as part of a system that includes a server computing device that receives data (e.g., content data comprising images, text segments, audio segments, and/or video segments) from a user’s client computing device, performs operations based on the data and sends output comprising modified content data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the detection, recognition, and/or classification of content data comprising images, audio, and/or video; the generation of modified content data comprising one or more modifications of the content data, prompt data, and/or context data, and/or the generation of one or more content recommendations based on the modified content data.

The computing system can receive, access, and/or retrieve content data. The content data can comprise content. The content can be associated with one or more data modalities. For example, the content data can comprise one or more images, one or more audio segments, one or more video segments. For example, the content data can comprise images or video segments copied from a web page, one or more text segments from a document, and/or content retrieved via an application (e.g., a social media application). The content data can comprise information (e.g., metadata) that can be used to determine context associated with the content data. For example, the content data can comprise image metadata that can indicate the ISO and other information about an image that was captured. In some embodiments, the computing system can be configured to deduplicate the content data that is received. For example, if one or more copies of the same content (e.g., the same image, audio segment, and/or video segment) are received, the computing system can remove the duplicate copies of the content.

The computing system can receive, access, and/or retrieve prompt data and/or one or more prompts. Further, the prompt data can comprise and/or be associated with one or more prompts. For example, the computing system can generate prompt data based on one or more prompts provided as input by a user into the computing system via an input device (e.g., a keyboard). The one or more prompts can be associated with one or more modifications of the content data. Further, the one or more prompts can comprise one or more indications (e.g., text-based instructions and/or audio instructions) of the one or more modifications. For example, the prompt data can indicate that a user wants to increase the size of an object. The prompt data and/or one or more prompts can be entered via an input device (e.g., keyboard and/or microphone). For example, if the content data comprises an image of a modest sized house, the prompt might indicate “MAKE THE HOUSE APPEAR LARGER AND MORE LUXURIOUS.”

In some embodiments, the one or more prompts can comprise one or more links (e.g., hyperlinks) to content. For example, the one or more prompts can comprise a link to a webpage associated with houses (e.g., a real estate webpage). The computing system can follow the link to the webpage and process the page to determine content that is associated with the webpage. For example, the link can be associated with an image or a text segment that can be used as a prompt. In some embodiments, the link can comprise a portion of the content and can be included together with an additional prompt text-based prompt provided by a user. In some embodiments, the one or more prompts can be based on one or more search results and/or one or more search queries. For example, a search query (e.g., houses in Chicago) can be included with content comprising an image of a house.

The computing system can determine one or more contexts associated with the content data. The computing system can determine the one or more contexts based on searching and/or processing data that can comprise location data, temporal data, event data, application data, search data, and/or information associated with a user. For example, the computing system can process metadata that is included in the content data and comprises indications of where the content data was generated and/or modified, one or more entities that generated and/or modified the content data (e.g., a user that generated and/or modified the content data), one or more times that the content data was generated or modified, a search history and/or search queries associated with the content data, and/or an application that accessed, generated, and/or modified the content data. Context data can be generated and/or determined based on the one or more contexts. The context data can comprise information and/or data associated with the one or more contexts. For example, the computing system can access the one or more contexts and/or information (or data) associated with the one or more contexts and generate and/or determine context data based on the one or more contexts. Further, the context data can be based on and/or comprise one or more contexts comprising one or more web browsing histories, one or more purchase histories, user profile data (e.g., profile data indicating the web services a user is associated with), and/or a link note history (e.g., a history of one or more link notes that a user generated, modified, sent, received, and/or viewed).

In some embodiments, a computing system can determine one or more contexts based on information associated with one or more locations. For example, information associated with the one or more locations can be based on location data associated with one or more locations (e.g., latitude, longitude, and/or altitude) at which content data was generated and/or modified. The location data can be included in the content data (e.g., metadata), in an application that generated the content data (e.g., a social media application that generated content data comprising text content). Further, the one or more machine-learned models can be configured and/or trained to generate the modified content data based on the information associated with the one or more locations. For example, the one or more machine-learned models can generate and/or determine the modified content data based on one or more features (e.g., visual features) of the location. For example, if the context indicates that a location is the home of a user, the modified content data generated by the one or more machine-learned models can remove personally identifiable information from the modified content data.

In some embodiments, the computing system can determine the one or more contexts based on one or more temporal indications that may be associated with one or more times at which the content data was generated or modified. For example, information associated with the one or more temporal indications can comprise time stamps that indicate one or more times at which the content data was generated and/or modified. The one or more temporal indications can be included in the content data, in an application that generated the content data (e.g., a web browser that indicates the time at which content data comprising an image or text segment was downloaded). Further, the one or more machine-learned models can be configured and/or trained to generate the modified content data based on the one or more temporal indications. For example, the one or more machine-learned models can be configured and/or trained to determine that an image was captured during a particular season and can generate modified content data that refers to the time of year. For example, if the context indicates that content was generated during the autumn and the content comprises an image of a car on the road, the modified content can comprise autumn leaves alongside the road.

In some embodiments, the computing system can determine the one or more contexts based on information associated with one or more events that may be associated with the content data. For example, information associated with the one or more events can comprise identifiers (e.g., the name of an event) and/or classes (e.g., a school days or non-school days) associated with one or more events. Further, the one or more machine-learned models can be configured and/or trained to generate the modified content data based on the one or more events. For example, if the context indicates that content was generated on a school day and the content comprises an image of a school building, the modified content data can comprise an image in which students and school faculty are gathered around the school building.

In some embodiments, the computing system can determine the one or more contexts based on information associated with one or more applications that may be associated with the content data. For example, the information associated with the one or more applications can comprise web browser data that indicates the times at which content data was downloaded or viewed, text message application data that may include the content of text messages (e.g., text, images, audio, and/or video content), email application data that may comprise the content of email messages, and/or social media application data that indicates social media postings that may be associated with the content data. The one or more machine-learned models can be configured and/or trained to generate the modified content data based on the information associated with the one or more applications. Further, the one or more machine-learned models can be configured and/or trained to detect, recognize, and/or classify the information associated with the one or more applications and generate the modified content data based on the information associated with the one or more applications. For example, if the context indicates that content was generated by a video streaming application that indicates the genre of a video segment viewed by a user, the modified content data can comprise visual effects that are similar to the video effects detected in the video segment.

In some embodiments, the computing system can determine the one or more contexts based on one or more search queries and/or search results that may be associated with the content data. For example, the information associated with the one or more search queries can comprise web browser data that indicates search queries associated with a user and/or a search history associated with a user. The one or more machine-learned models can be configured and/or trained to generate the modified content data based on the one or more search queries and/or search results. Further, the one or more machine-learned models can be configured and/or trained to detect, recognize, and/or classify the one or more search queries and/or search history and generate the modified content data based on the one or more search queries. For example, if the context is based on a search history that indicates a user’s interest in astronomy, content comprising an image of a night sky can result in modified content data comprising a night sky that is emphasized with brighter stars.

In some embodiments, the computing system can determine the one or more contexts based on information associated with one or more users that may be associated with the content data. For example, the information can be based on data associated with a user logged into an application (e.g., a social media application), a user providing their name as part of the prompt data, and/or an online account (e.g., an account for a web service). Further, the one or more machine-learned models can be configured and/or trained to generate the modified content data based on the information associated with the one or more users. For example, if the context comprises information associated with a user’s food preferences modifications to images of food can reflect the food preferences and include or exclude certain types of food.

The computing system can generate modified content data. The modified content data can be based on data comprising the content data, the context data, and/or the prompt data. The one or more machine-learned models can be configured and/or trained to detect, recognize, and/or classify one or more features of the content data, the context data, and/or the prompt data. Further, the modified content data can be generated and/or determined based on inputting the content data, the context data, and/or the prompt data into one or more machine-learned models that can be configured to generate modified content data that can comprise one or more modifications of one or more features (e.g., one or more visual features, one or more textual features, and/or one or more audio features) of the content data.

In some embodiments, the modified content data can comprise a plurality of different versions of the content comprising one or more different modifications of the one or more features of the content data. For example, a modified content data based on an image of a house can comprise a plurality of different versions of the house with a different number of levels, different roof materials, different walls (e.g., stone or wood), different lawns, different numbers of windows, and/or different numbers of doors. Further, the one or more content recommendations can be based on the plurality of different versions of the content. For example, the one or more content recommendations can correspond to each of the plurality of different versions of the content. Further, the computing system can generate a user interface that is configured to detect one or more inputs to select at least one of the one or more content recommendations.

In some embodiments, the computing system can generate the modified content data based on detection, recognition, and/or classification of one or more features of the content data, the prompt data, and/or the context data. The one or more machine-learned models can comprise one or more generative models that are configured and/or trained to generate the modified content data. In some embodiments, the computing system can implement one or more machine-learned models comprising a large language model (LLM), an image diffusion model, a video segment diffusion model, and/or an audio segment diffusion model. The one or more machine-learned models can be configured and/or trained to generate modified content data based on input comprising the content, the context data, and/or the prompt data.

The one or more machine-learned models can comprise one or more multimodal generative models (e.g., one or more multimodal transformer models) that are trained to generate the modified content data based on training data. The training data can comprise training content, a plurality of training prompts (e.g., training prompt data), and a plurality of training contexts. The training content data can comprise a plurality of training images, a plurality of training audio segments, a plurality of training video segments, a plurality of training prompts, and/or a corresponding plurality of ground-truth audio segments. Further, the training context data can comprise a plurality of training locations, a plurality of training temporal indications, a plurality of training applications, a plurality of training identified users, a plurality of training search results, and/or a plurality of training search queries. In some embodiments, the training data can comprise a plurality of embeddings. The plurality of embeddings can comprise a lower-dimensional vector space representation of the training data. For example, training images can be represented in a lower-dimensional vector space that can preserve key features of the images in a smaller dimensional vector space than the higher-dimensional vector space of the original image (e.g., a high-dimensional vector space that can include RGB values for the millions of pixels in an image). The plurality of embeddings can be arranged such that semantically similar content is closer together in the vector space. The plurality of embeddings can be generated based on the training content data, training prompt data, and/or training context data. For example, the plurality of embeddings can be generated based on inputting the training data into one or more machine-learned models configured and/or trained to generate the plurality of embeddings.

Generating the modified content data can comprise determining one or more portions of the content data that comprise personally identifiable information. For example, the computing system can perform one or more image recognition operations on content data comprising an image in order to detect personally identifiable information (e.g., an image of a credit card) in the image. The personally identifiable information comprises one or more names, one or more addresses, one or more street addresses, and/or one or more vehicle license plate numbers.

Generating the modified content data can comprise generating one or more alternative images in the one or more portions of the content data that comprise the personally identifiable information. The one or more alternative images can conceal the personally identifiable information. For example, if the content data comprises image content the computing system can generate a blurred version of the content that obscures or conceals the content in the one or more portions of the image content that were determined to comprise personally identifiable information. In some embodiments, the one or more portions of the image that comprise the personally identifiable information can be replaced with a predicted background image.

Generating the modified content data can comprise generating modified content data comprising one or more video segments based on the image. For example, the computing system can implement one or more machine-learned models that are configured and/or trained to perform one or more object recognition operations and determine one or more segments of an image that comprise objects that have a higher probability of moving (e.g., a squirrel or a motorcycle can have a higher probability of moving than a lamppost or tree). The one or more machine-learned models implemented by the computing system can then generate one or more video segments based on the image. For example, a video segment of a bird flying can be generated based on an image of the bird sitting in the tree.

Generating the modified content data can comprise detecting one or more faces in one or more portions of the image. For example, the computing system can implement one or more machine-learned models that are configured and/or trained to perform one or more object recognition operations on content data comprising an image in order to detect and/or recognize one or more faces in the image.

Generating the modified content data can comprise generating one or more modified faces in the one or more portions of the image in which the modified content data comprises the one or more faces. For example, the computing system can implement one or more machine-learned models that are configured and/or trained to generate modified content data (e.g., a modified image of face such that the face comprises different features such as a different hairstyle) based on input comprising content comprising an image of the face, a prompt to modify the content comprising the image of the face, and/or context associated with the content comprising the image of the face. In some embodiments, the one or more modified faces can be based on one or more modifications of one or more facial expressions of at least one face of the one or more faces or one or more modifications of an apparent age of at least one face of the one or more faces.

Generating the modified content data can comprise detecting one or more portions of the image comprising a background. For example, the computing system can implement one or more machine-learned models that are configured and/or trained to perform one or more image segmentation operations on content data comprising an image and/or video in order to detect one or more portions of the image and/or video that comprise a foreground and/or background.

Generating the modified content data can comprise generating a modified background in the one or more portions of the image comprising the background. The modified content data can comprise the modified background. For example, the computing system can implement one or more machine-learned models that are configured and/or trained to generate modified content data (e.g., a background) in one or more portions of an image that are determined to be a background of the image. For example, building in the background of an image can be modified to appear like a cluster of trees.

In some embodiments, the content data can comprise an image. Further, the one or more prompts can comprise one or more selections indicating one or more portions of the image to modify. Additionally, the one or more modifications of the one or more features of the content data can comprise one or more modifications of the one or more portions of the image indicated in the one or more selections. For example, a user can select a portion of an image to remove such as removing a person from an image of a group of people.

In some embodiments, the content can comprise an image. Further, the one or more machine-learned models can be configured and/or trained to detect one or more objects in the image. Further, the one or more modifications can comprise one or more modifications of a size of at least one object of the one or more objects in the image, removal of at least one object of the one or more objects in the image, and/or the addition of at least one object to the one or more objects in the image.

In some embodiments, the content can comprise a video segment. Further, the one or more machine-learned models can be configured and/or trained to detect one or more objects in the video segment. Further, the one or more modifications can comprise one or more modifications of a size of at least one object of the one or more objects in the video segment, removal of at least one object of the one or more objects in the video segment, and/or the addition of at least one object to the one or more objects in the video segment.

The one or more machine-learned models can be configured and/or trained to perform one or more object processing operations (e.g., object detection operations) to detect, recognize, and/or classify one or more objects in the content data (e.g., content data comprising one or more images and/or one or more video segments). The one or more machine-learned models can be configured and/or trained to generate the modified content data based on the detection, recognition, and/or classification of one or more objects in the content data. For example, the one or more machine-learned models can detect one or more portions of an image comprising a background, a foreground, one or more tools, one or more animals, one or more vehicles, one or more buildings, one or more musical instruments, sports equipment, one or more faces, one or more roads, one or more plants, and/or natural geographic features in content data. Based on a prompt to change an image in bright sunlight to an image at night, the one or more machine-learned models can generate modified content data in the one or more portions of the image comprising the background sky is changed to a night sky. In some embodiments, the one or more machine-learned models can be configured to recognize one or more objects in the content data and determine the modified content data based on the recognition of the one or more objects. For example, the one or more machine-learned models can recognize a bird in a tree and generate modified content data in which the bird is replaced with a squirrel or a cat.

The one or more machine-learned models can be configured and/or trained to perform one or more audio processing operations to detect, recognize, and/or classify one or more audio features of the content data (e.g., content data comprising audio segments associated with music, background sounds, and/or speech). The one or more machine-learned models can be configured and/or trained to generate the modified content data based on the detection, recognition, and/or classification of one or more audio features of the content data. For example, the one or more machine-learned models can detect speech in input comprising content data comprising an audio segment of a conversation between a group of people. The one or more machine-learned models can then generate modified content data in which the speech of the group of people is quieter, louder, has a different cadence, a different pitch, and/or one or more voices are muted.

The computing system can generate one or more content recommendations. The one or more content recommendations can be based on the modified content data. For example, the one or more content recommendations can comprise one or more portions of the modified content data (e.g., an image, a video segment, and/or an audio segment). Further, the one or more content recommendations can be generated in a format based on a type of application that will use the one or more content recommendations. For example, the one or more content recommendations can be formatted for use in a posting on a social media platform associated with a social media application.

In some embodiments, the one or more machine-learned models can be configured and/or trained to generate the modified content data. Training the one or more machine-learned models to generate the modified content data can comprise receiving training data.

The training content data can comprise a plurality of training data inputs and a corresponding plurality of portions of ground-truth modified content data. The plurality of training data inputs can comprise training content data, training context data, and/or a plurality of training prompts. The training content data can comprise a plurality of training images, a plurality of training text segments, a plurality of training audio segments, and/or a plurality of training video segments. The training context data can comprise a plurality of training locations associated with the training content data, a plurality of temporal indications associated with the training content data, training application information associated with the training content data, a plurality of search queries and/or search histories associated with the training content data, training information associated with a user and the training content data, and/or training event data associated with the training content data. In some embodiments, the training data can comprise a plurality of embeddings based on output from an embedding generation model that generated the plurality of embeddings based on the training data. The plurality of portions of ground-truth modified content data can comprise ground-truth images, ground-truth video segments, and/or ground-truth text segments that comprise accurate modifications of training data inputs based on training content, training prompts, and/or training context.

Further, training the one or more machine-learned models can comprise generating, based on inputting the training data into the machine-learned model, a plurality of portions of predicted modified content data. Based on the received input, the one or more machine-learned models can perform one or more operations and generate an output comprising a plurality of portions of predicted modified content data associated with the corresponding plurality of training data inputs. The output of the one or more machine-learned models can then be evaluated based on one or more comparisons of the plurality of portions of predicted modified content data to a corresponding plurality of portions of ground-truth modified content data associated with the training data.

Training the one or more machine-learned models can comprise determining a loss based on one or more differences between the plurality of portions of predicted modified content data and the portions of ground-truth modified content data. For example, a loss function may be used to determine the loss. The loss function may be used to evaluate the one or more differences between the plurality of portions of predicted modified content data and the plurality of portions of ground-truth modified content data. The loss can increase in proportion to a number of differences between the plurality of portions of predicted modified content data and the plurality of portions of ground-truth modified content data. For example, if there are eight differences between the plurality of portions of predicted modified content data and the plurality of portions of ground-truth modified content data, the loss can be greater than if there is one difference between the plurality of portions of predicted modified content data and the plurality of portions of ground-truth modified content data.

Further, the loss may increase in proportion to the magnitude of differences between the plurality of portions of predicted modified content data and the plurality of portions of ground-truth modified content data. For example, a portion of predicted modified content data that is very different from a portion of ground-truth modified content data (e.g., a predicted video segment that comprises a video of cats playing ping pong when the ground-truth video is a video of people rowing) may result in a greater loss than a predicted segment that is less different from a portion of ground-truth modified content data (e.g., a predicted video segment that comprises video of people kayaking when the ground-truth video is a video of people rowing).

Training the one or more machine-learned models can comprise modifying a plurality of parameters of the one or more machine-learned models to minimize the loss. The plurality of parameters can be associated with detection, recognition, and/or classification of one or more features of the training data that can be used to determine the portions of predicted modified content data. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameter can be associated with the plurality of portions of predicted modified content data such that parameters that are more heavily weighted can contribute more to determining the portions of predicted modified content data than parameters that are less heavily weighted. Over the plurality of iterations, the weights of the plurality of parameters can be modified to minimize the loss until a threshold loss that corresponds to a high accuracy of the one or more machine-learned models determining the plurality of portions of predicted modified content data is achieved. For example, the loss can be minimized until a threshold loss associated with 99% accuracy is achieved by the machine-learned model.

The computing system can generate a link note which can comprise content (e.g., user generated content that can include one or more content recommendations including modified content data) that can be associated with one or more web resources. Further, the content included in a link note can comprise one or more images, one or more text segments, one or more video segments, one or more audio segments, and/or one or more links associated with one or more web resources. For example, a link note can comprise a user’s step by step instructions of how to assemble a wooden chair, an image of the wooden chair, and a link (e.g., a hyperlink) to a webpage with other user content (e.g., instructions to assemble other types of furniture) that can be displayed in an interface (e.g., graphical user interface) of a web browser when search results are provided in response to a search for instructions to assemble a chair. In some embodiments, a link note can be indicated in in a separate interface (e.g., a link note interface) and/or as part of another interface (e.g., a web browser interface and/or search engine interface).

A link note can be associated with search results and can comprise a characterization of a search result and/or one or more web resources indicated in a search result. For example, a link note comprising a website review with one or more user comments indicating the quality and/or usefulness of a web site can be included alongside search results that include the website or other websites that are similar. Further, a link note can comprise information associated with a topic indicated in a search result and/or one or more web resources. For example, a link note comprising a book review (e.g., a video segment comprising a user’s analysis and/or rating of a particular book) can be included next to search results based on a search for reviews about the book indicated in the link note. In some embodiments, a plurality of link notes can be aggregated in a link notes interface and/or a collections interface that may be used to provide users with information on web resources including reviews and/or ratings of web resources.

A link note can comprise one or more links (e.g., one or more hyperlinks) to one or more web resources that can be associated with the one or more content recommendations. The one or more web resources can comprise resources that are accessible via a network (e.g., the Internet). Further, the one or more web resources can comprise one or more search results, one or more web sites, one or more web pages, one or more database entries, one or more documents, and/or one or more social media posts. For example, a link note comprising a content recommendation can comprise a modified image of a user dressed in a Halloween costume based on an image of the user wearing ordinary (non-Halloween) clothing. Further, the link note can comprise a link to the user’s personal website and/or social media pages.

Further, a link note can comprise information associated with a time the link note was generated, modified, and/or sent; a user associated with the link note (e.g., the user that generated the link note and/or a recipient of the link note); a location at which the link note was generated or modified; an application that was used to generate the link note; and/or an email address associated with the link note (e.g., the email address of an individual user or business associated with the link note). One or more portions of the information in the link note can be selectively shared based on the preferences of the user sharing the link note. For example, a user may share their email address in link notes sent to one group of users and not share their email address in the link notes sent to a different group of users.

In some embodiments, a link note can be sent to one or more users and/or embedded in a web resource (e.g., a webpage). For example, a link note can be shared with one or more users from the sender of the link note’s contact list. Further, a link note can be embedded and/or included in a social media post, an online review, an online forum post, and/or a search result. For example, a link note comprising an image of a restaurant and modified content data comprising an exaggeratedly large image of the food portions and a description of the generous serving sizes at the restaurant can be included in a restaurant review that is provided as the result of a search for a review about that particular restaurant.

The systems, methods, devices, and/or computer-readable media (e.g., tangible non-transitory computer-readable media) in the disclosed technology can provide a variety of technical effects and benefits including an improvement in the effectiveness with which modified content data comprising images, audio segments, text segments, and/or video segments can be generated based on the detection, recognition, and/or classification of features (e.g., low-level visual features and/or low-level audio features) of content data. Further, improved generation of modified content data based on the detection, recognition, and/or classification of features of content data including images, audio, and/or video can assist a user by providing more relevant and/or appropriate modified content that can enhance a user’s privacy by automatically modifying personally identifiable information. The disclosed technology can also improve the effectiveness with which computational resources are used by leveraging one or more machine-learned models that are able to determine features (e.g., visual features, textual features, and/or audio features) more efficiently.

Further, the disclosed technology can improve the effectiveness with which content is searched for, retrieved, and/or distributed from a variety of data sources. The large volume of content that is available on the Internet can present the arduous task of searching for relevant content. In many cases, the content a user searches for turns out to be irrelevant or deliberately misleading (e.g., misinformation). The ability to quickly generate relevant modified content based on existing content that can be shared with trusted users in the form of a link note can significantly reduce inefficiencies involved in the search, retrieval, and/or manual modification of content.

Additionally, the disclosed technology can automatically generate modified content data based on the modification of features of multimodal content data which can include images, text, audio, and/or video. For example, a video may be generated based on a still image that is automatically processed. In this way, the time-consuming task of manually finding appropriate content or manually modifying content can be automatically performed by the disclosed technology.

As such, the disclosed technology can allow the user of a computing system to perform the technical task of generating modified content data based on the detection, recognition, and/or classification of features of content data (e.g., images, text, audio, and/or video). As a result, users can be provided with the specific benefits of improved performance (classification performance and/or content generation performance) and more efficient use of system resources. Further, any of the specific benefits provided to users can be used to improve the effectiveness of a wide variety of devices and services including devices that use modified content data. Accordingly, the improvements offered by the disclosed technology can result in tangible benefits to a variety of devices and/or systems including mechanical, electronic, and computing systems associated with generating modified content data.

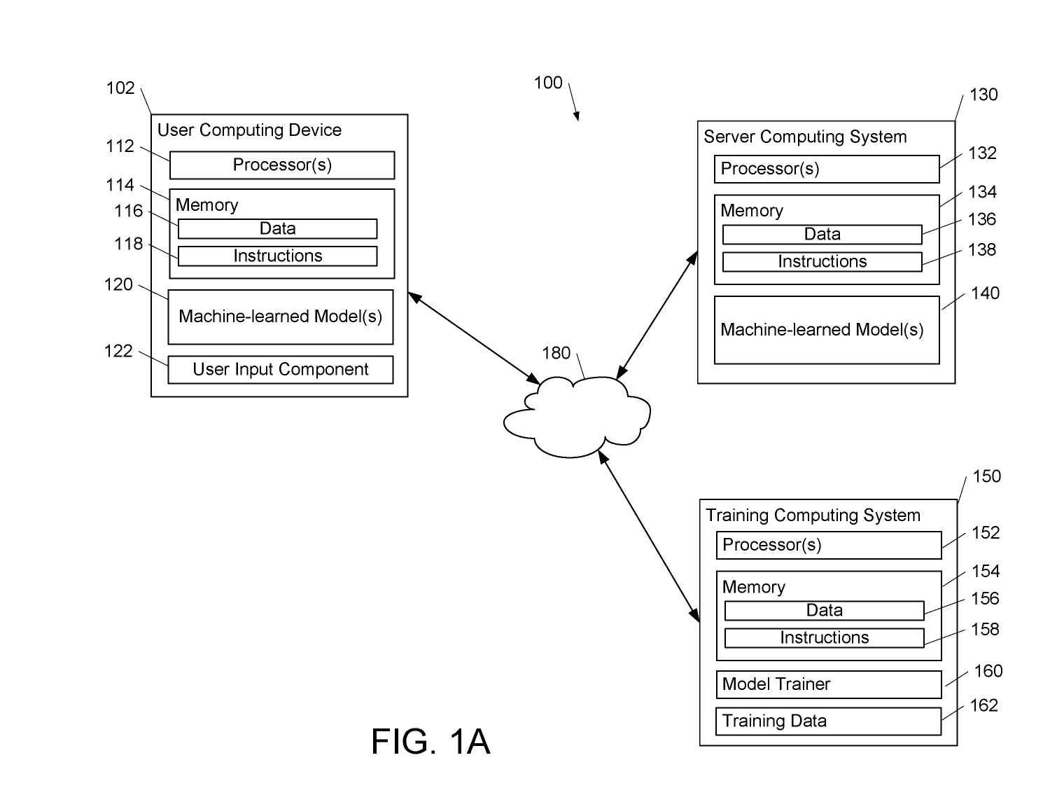

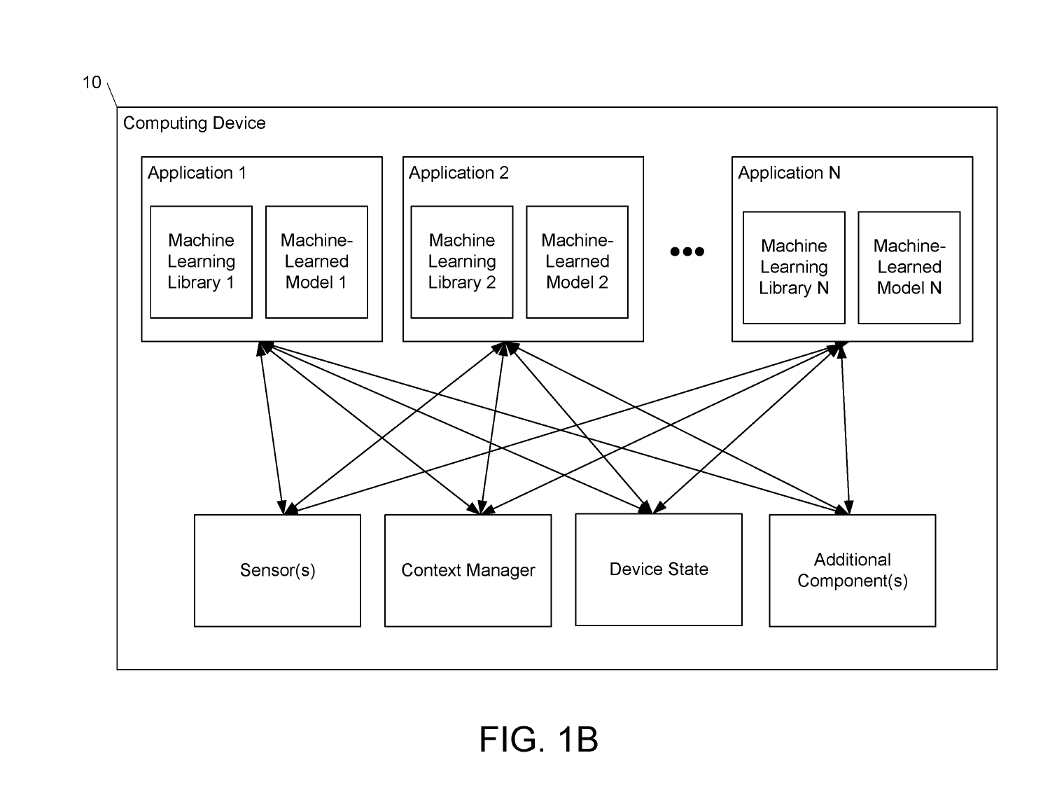

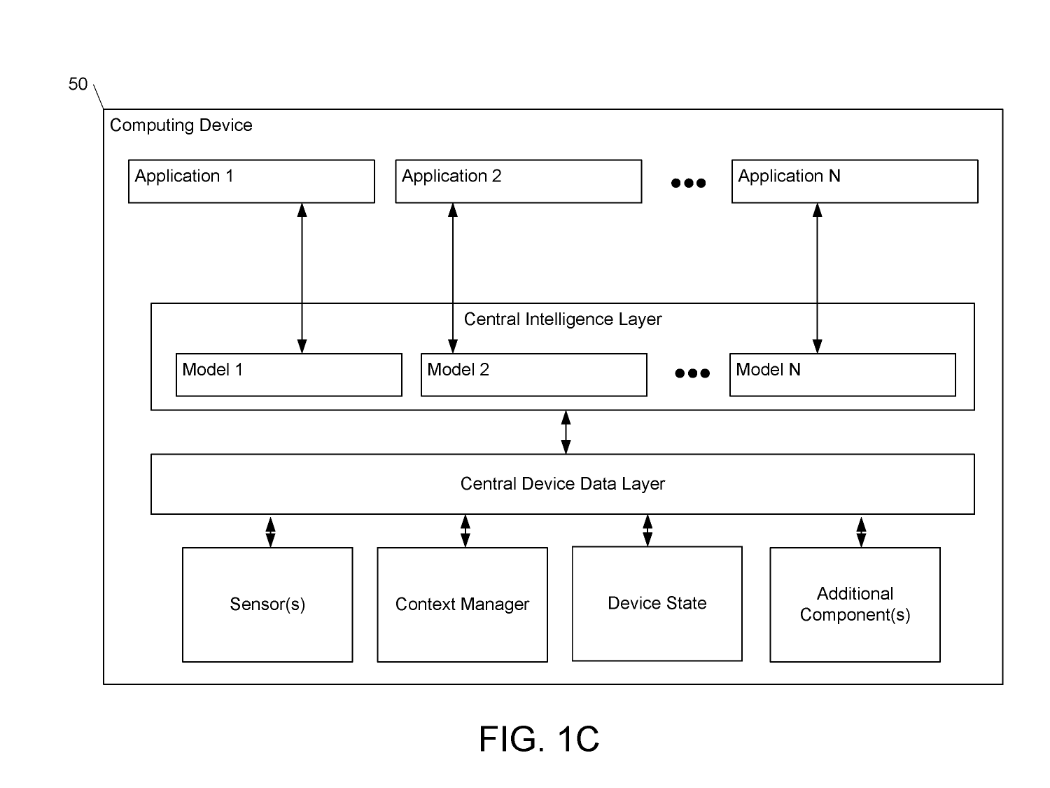

With reference now to the figures, example embodiments of the present disclosure will be discussed in further detail. FIG. 1A depicts a block diagram of an example of a computing system that can generate modified content data according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more encoders, one or more decoders, and/or one or more embedding models. Examples of one or more machine-learned models 120 are discussed with reference to FIGS. 1-13.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel modified content data generation operations across multiple instances of the one or more machine-learned models 120).

More particularly, the one or more machine-learned models 120 can comprise one or more machine-learned models (e.g., one or more LLMs) that are configured and/or trained to perform operations comprising receiving content data associated with one or more data modalities, receiving one or more prompts associated with modification of the content data, determining contexts associated with the content data, generating, based on inputting the content data, one or more prompts, and/or context data based on the contexts into a machine-learned model, modified content data based on the content data, and/or generating one or more content recommendations based on the modified content data.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., content data modification service and/or a content data generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-13.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include content data, context data, prompt data, and/or other data that is associated with the detection, recognition, and/or classification of one or more features of images, audio segments, multimodal segments, and/or video segments; the generation of modified content data comprising one or more modifications of one or more features of the content data; and the generation of one or more content recommendations based on the modified content data. For example, the training data 162 can comprise training content comprising a plurality of training content inputs, a plurality of training context inputs, a plurality of training prompts, and a corresponding plurality of ground-truth modified content data that accurately comprises modifications based on the plurality of training inputs. The training data 162 can comprise a plurality of training prompts that can comprise information associated requests or information associated with the training content (e.g., a prompt requesting the modification of an image, video segment, or audio segment). Further, the training data 162 can comprise a plurality of training contexts that comprise information associated with contexts associated with the training content (e.g., locations, temporal indications, events, applications, search queries, and/or users associated with the training content). The model trainer 160 can train and/or retrain the one or more machine-learned models 120 and/or the one or more machine-learned models 140 based on additional data from the training data 162 which can comprise additional content data (e.g., updated content data), additional context data, additional prompt data, new types of content data, context data, and/or prompt data (e.g., new types of content data based on new content formats), and/or one or more modifications to existing content data, context data, and/or prompt data.

In some implementations, if a user has provided consent (e.g., the user provides affirmative consent for another party to use the user’s content data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can comprise any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio data or visual data).

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that generates modified content data according to example embodiments of the present disclosure. A computing device 10 can comprise a user computing device or a server computing device.

The computing device 10 can include a number of applications (e.g., applications 1 through N). Each application contains its own machine-learned library and machine-learned model(s). For example, each application can include a machine-learned model. Example applications include a content data processing application, a context data processing application, a prompt processing application, a social media application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that generates modified content data according to example embodiments of the present disclosure. A computing device 50 can comprise a user computing device or a server computing device.

The computing device 50 includes a number of applications (e.g., applications 1 through N). Each application is in communication with a central intelligence layer. Example applications include a content processing application (e.g., an application that is used to process content data, prompt data, and/or context data, generate modified content data based on the content data, prompt data, and/or the context data, and generate one or more content recommendations based on the modified content data), a social media application, a text messaging application, an email application, a dictation application, a virtual keyboard application, and/or a browser application (e.g., an Internet browser). In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a content manager, a context manager, a prompt manager, a device state component, and/or additional components. In some implementations, the central device data layer can communicate with each device component using an API (e.g., a private API).

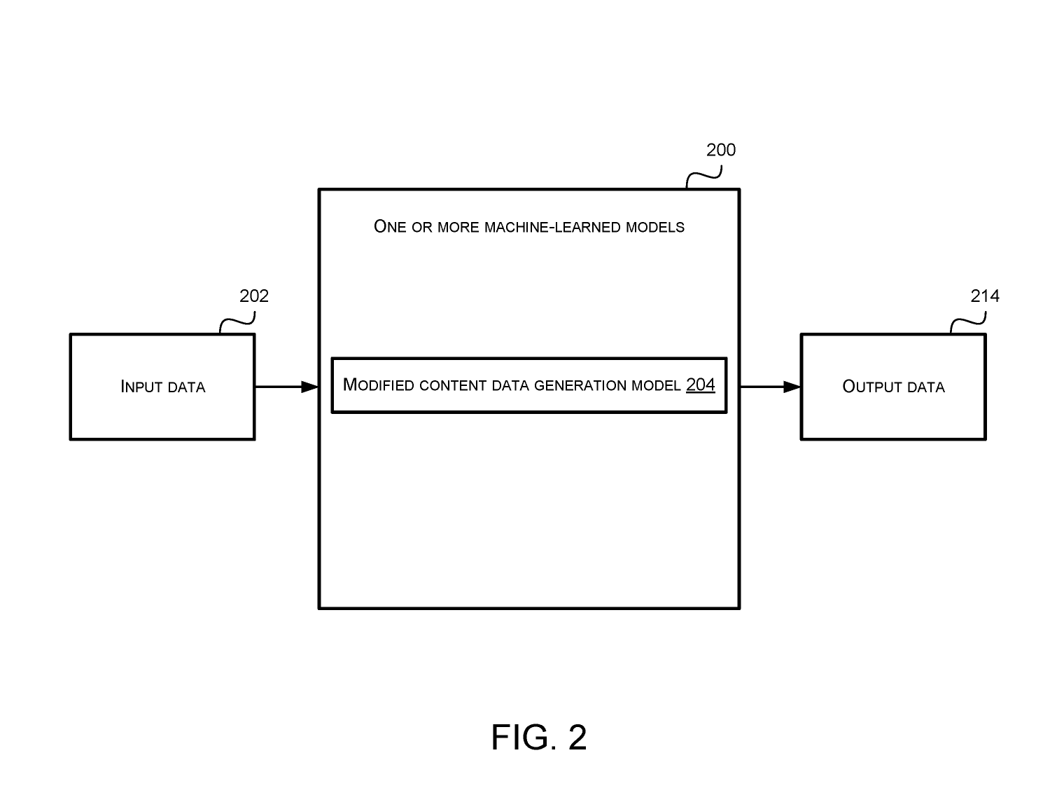

FIG. 2 depicts a block diagram of examples of machine-learned models according to example embodiments of the present disclosure. In some implementations, the one or more machine-learned models 200 can be trained to receive input data 202 that can comprise content data associated with one or more data modalities (e.g., images, audio segments, text segments, multimodal segments, and/or video segments), prompt data associated with one or more prompts, and/or context data associated with the content data (e.g., location data, temporal data, event data, application data, search data, and/or information associated with a user). As a result of receipt of the input data 202 the one or more machine-learned models 200 can generate output data 214 that can comprise modified content data based on detection, recognition, and/or classification of one or more features of the content data, prompt data, and/or the context data; and modification of one or more features of the content data based on the prompt data and/or the one or more prompts.

In some implementations, the one or more machine-learned models 200 can include a content modification model 204 that is operable to generate modified content data based on the input data 202 (e.g., the content data, prompt data, and/or the context data).

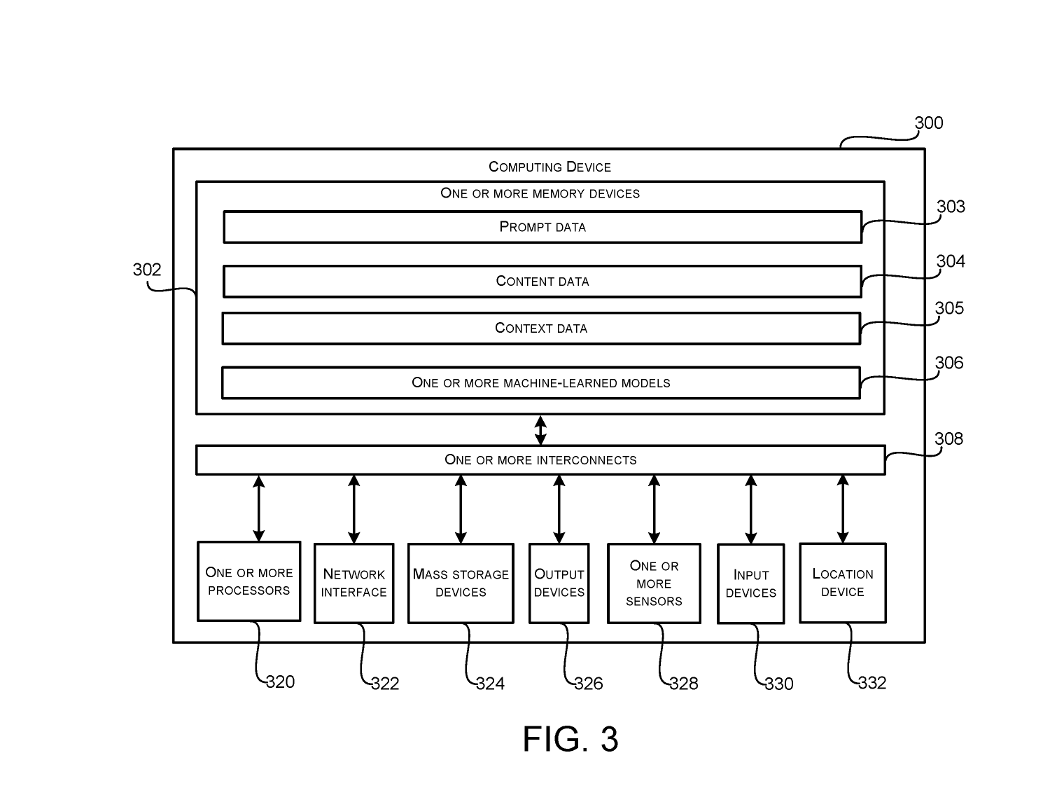

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, prompt data 303, content data 304, context data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., modified content data) based on content detected by the one or more sensors 328 (e.g., images captured by a camera of the device 300) of the computing device 300 and/or data that is received from another computing device (e.g., content data that is generated by a remote computing device).

The one or more memory devices 302 can store information and/or data (e.g., the content data 304, the context data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations comprising receiving content data associated with one or more data modalities, receiving one or more prompts associated with modification of the content data, determining contexts associated with the content data, generating, based on inputting the content data, one or more prompts, and/or context data based on the contexts into a machine-learned model, modified content data based on the content data, and/or generating one or more content recommendations based on the modified content data.

The prompt data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The prompt data 303 can be generated based on one or more inputs via the one or more input devices 330. For example, the prompt data can comprise text based on inputs via a keyboard (e.g., mechanical keyboard and/or touchscreen keyboard), touch inputs via a touchscreen (e.g., selection of one or more portions of an image displayed on a touchscreen), and/or audio input via a microphone. In some embodiments, the prompt data 303 can be received from one or more computing systems (e.g., the server computing system 130 that is depicted in FIG. 1) which can include one or more computing systems that are remote from the computing device 300. The prompt data 303 can comprise one or more text segments (e.g., a text prompt), one or more tactile prompts (e.g., a prompt received via selection of content on a touchscreen), and/or one or more audio segments (e.g., an audio prompt).

The content data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the content data 304 can be received from one or more computing systems (e.g., the server computing system 130 that is depicted in FIG. 1) which can include one or more computing systems that are remote from the computing device 300. The content data 304 can comprise one or more images, one or more audio segments, one or more video segments, one or more multimodal segments, and/or one or more text segments. Further, the content data 304 can comprise information (e.g., metadata) associated with one or more locations at which the content data 304 was generated, modified, and/or accessed; one or more times at which the content data 304 was generated, modified, and/or accessed; one or more events associated with the content data 304; one or more applications associated with the content data 304; one or more search queries associated with the content data 304; and/or one or more users associated with the content data 304.

The context data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the context data 305 can include information associated with one or more contexts of the content data 304 and/or a user of the computing device 300 including location data, temporal data, event data, application data, search data, and/or information associated with a user. In some embodiments, the context data 305 can be received from one or more computing systems (e.g., the server computing system 130 that is depicted in FIG. 1) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can be configured and/or trained to perform operations comprising receiving content data associated with one or more data modalities, receiving one or more prompts associated with modification of the content data, determining contexts associated with the content data, generating, based on inputting the content data, one or more prompts, and/or context data based on the contexts into a machine-learned model, modified content data based on the content data, and/or generating one or more content recommendations based on the modified content data. In some embodiments, the one or more machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the prompt data 303, the content data 304, the context data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the prompt data, the content data 304, the context data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., the prompt data 303, the content data 304, and/or the context data 305) from other computing devices. The one or more mass storage devices 324 (e.g., a hard disk drive and/or a solid-state drive) can be used to store data including the content data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images, audio segments, multimodal segments, and/or video segments associated with the content data 304.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including modified content data based on the prompt data 303, the content data 304, and/or the context data 305. The one or more memory devices 302 can be used to operate various applications including a mobile operating system developed specifically for mobile devices. As such, the one or more memory devices 302 can store instructions that allow the software applications to access data including data associated with the generation of modified content data based on the prompt data 303, the content data 304, and/or the context data 305. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

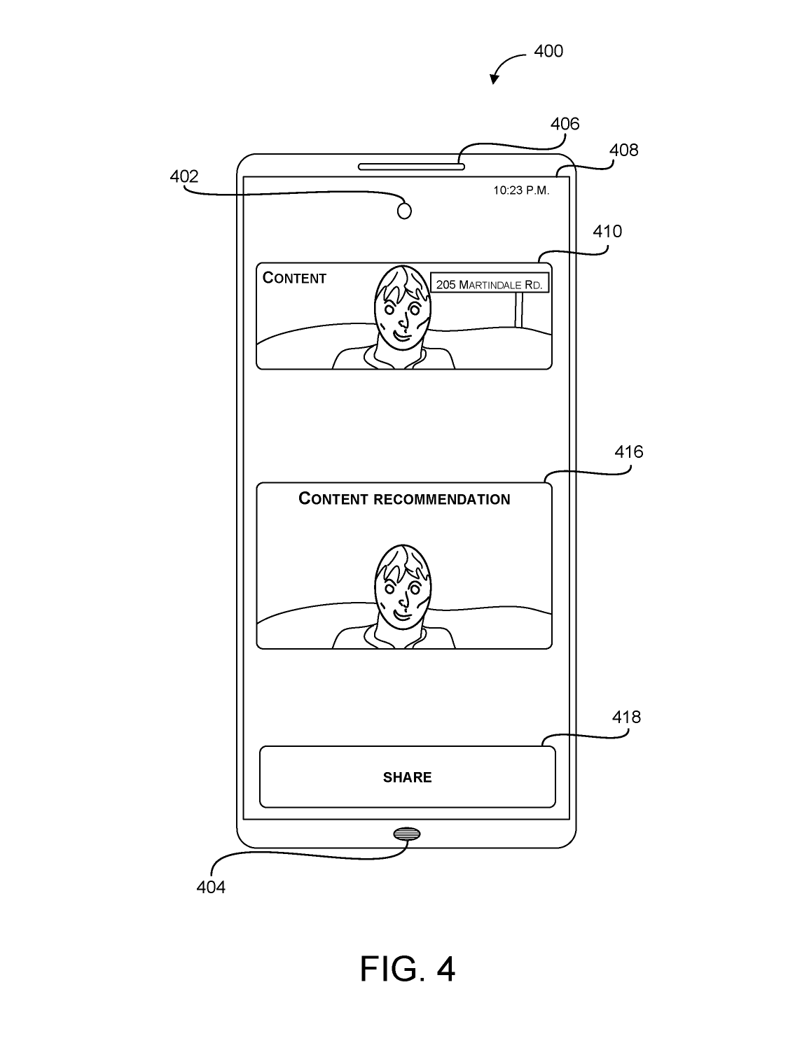

FIG. 4 depicts an example of removing personally identifiable information in content according to example embodiments of the present disclosure. A computing device 400 can include one or more features and/or capabilities of the computing device 102, the server computing system 130, the training computing system 150, and/or the computing device 300. Furthermore, the computing device 400 can perform one or more actions and/or operations that can be performed by the computing device 102, the server computing system 130, the training computing system 150, and/or the computing device 300.

The computing device 400 can include an imaging component 402, an audio input component 404, an audio output component 406, a display component 408, content 410, one or more content recommendations 416, and/or interface element 418.

The computing device 400 can be configured to perform one or more operations comprising sending, receiving, processing, and/or generating data comprising content data (e.g., content data based on the content 410), context data, prompt data, and/or other data received by the computing device 400. In some embodiments, the imaging component can be used to generate the content 410 or capture an image of a user that may be used to verify the user’s identify and determine whether a user is authorized to perform one or more operations on the computing device 400 (e.g., sharing the one or more content recommendations 416). Further, the computing device 400 can be configured to generate the one or more content recommendations 416.

In this example, the computing device 400 has received the content 410, which comprises an image and/or video of a person in the foreground and a street address sign that is in the background of the image, indicates “205 MARTINDALE RD.” and is displayed on the display component 408. In some embodiments, the content 410 can comprise one or more audio segments (e.g., music or sound effects). In this example, no prompt was provided and the one or more content recommendations 416 can be generated without receiving or using a prompt. In some embodiments, the computing device 400 can be configured to generate one or more content recommendations that can be selected by a user. The computing device can generate different versions of the content 410 that can be included in the one or more content recommendation 416. For example, the different versions of the content 410 can include versions in which the entire street address sign in the content 410 is blurred or covered, a version in which some portion of the street address sign (e.g., the “205” portion or the “MARTINDALE RD.” portion are blurred or covered, and/or the content 410 is framed differently (e.g., cropped differently or captured from a different angle) so that the street address sign is not visible in the content 410.

In some embodiments, one or more portions of the content 410 can be removed or obscured based on one or more inputs from a user. For example, the display component 408 can comprise a touch sensitive display that can detect tactile inputs from a stylus or a user’s finger. A user can touch one or more portions of the image that the user would like to remove or modify. Further, in some embodiments a user can provide a prompt to remove one or more portions of the content 410. For example, a user can provide a prompt indicating “REMOVE THE STREET ADDRESS SIGN” which could cause the computing device 400 to generate modified content to include in a content recommendation in which the street address sign was removed. By way of further example, the prompt “REMOVE PERSONALLY IDENTIFIABLE INFORMATION” could cause the computing device 400 to recognize personally identifiable information in the content 410 and generate modified content to include in a content recommendation that does not include the personally identifiable information.

The computing device 400 can determine one or more contexts based on content data associated with the content 410 and/or the prompt 412. For example, the computing device 400 can determine that the content data associated with the content 410 comprises location data indicating the geographic location at which the content 410 was captured. Further, the computing device 400 can determine that the geographic location is the residence of the user shown in the content 410.

The computing device 400 can use content data (e.g., content data associated with the content 410) and/or context data (e.g., context data associated with the content 410 and/or the prompt 412) as input to one or more machine-learned models that can be implemented on the computing device 400 and/or that are implemented on a remote computing device that is able to send data to and/or receive data from the computing device 400. The one or more machine-learned models can be configured and/or trained to recognize and/or classify one or more features of the content data, prompt data, and/or the context data. For example, the one or more machine-learned models can perform object detection, object recognition operations, and/or object classification operations to determine that the content 410 is an image of a person and that a street address sign is visible in the background. Additionally, the one or more machine-learned models can be configured to perform optical character recognition operations on the street address sign and determine that the street address is the street address of the user shown in the content 410.

The one or more machine-learned models can then use the content features, context features, and/or prompt features that were determined to generate the one or more content recommendations 416 include modified content based on the content 410 and comprising an image that includes the person in the image and does not include the street address sign.

Additionally, the interface element 418 which indicates “SHARE” can be used to send the one or more content recommendations 416 including the image of a user with personally identifiable information removed via one or more applications comprising a social media application, a text message application, and/or an email application. Further, the one or more content recommendations 416 can be used to generate a link note that can be shared with one or more users, one or more user groups, and/or included in a web resource. The one or more content recommendations 416 can be shared based on the computing device 400 detecting a user touching the portion of the user interface that comprises the interface element 418.

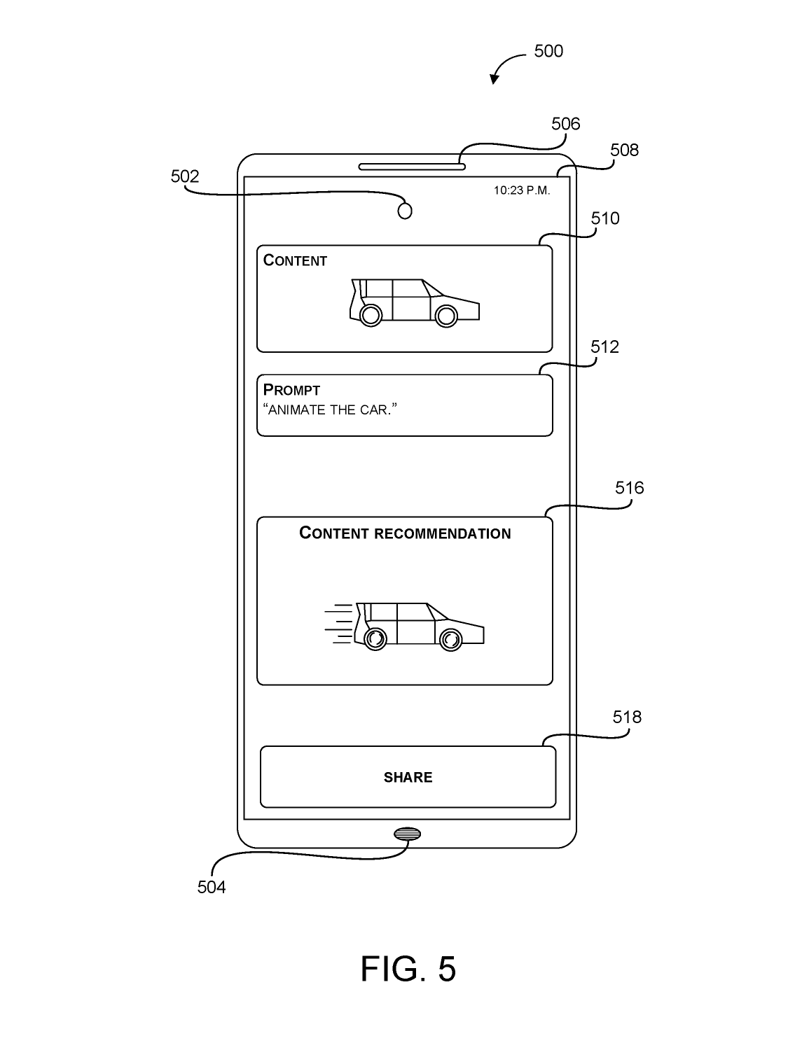

FIG. 5 depicts an example of generating video based on an image according to example embodiments of the present disclosure. A computing device 500 can include one or more features and/or capabilities of the computing device 102, the server computing system 130, the training computing system 150, the computing device 300, and/or the computing device 400. Furthermore, the computing device 500 can perform one or more actions and/or operations that can be performed by the computing device 102, the server computing system 130, the training computing system 150, the computing device 300, and/or the computing device 500.

The computing device 500 can include an imaging component 502, an audio input component 504, an audio output component 506, a display component 508, content 510, a prompt 512, one or more content recommendations 516, and/or interface element 518.

The computing device 500 can be configured to perform one or more operations comprising sending, receiving, processing, and/or generating data comprising content data (e.g., content data based on the content 510), context data, prompt data, and/or other data received by the computing device 500. In some embodiments, the imaging component can be used to generate the content 510 or capture an image of a user that may be used to verify the user’s identify and determine whether a user is authorized to perform one or more operations on the computing device 500 (e.g., sharing the one or more content recommendations 516). Further, the computing device 500 can be configured to generate the one or more content recommendations 516.

In this example, the computing device 500 has received the content 510, which comprises an image of an automobile, that is displayed on the display component 508. In some embodiments, the content 510 can comprise one or more audio segments (e.g., music or sound effects) that can accompany an image or video or be included without an accompanying image or video. Further, the computing device 500 has received the prompt 512, which is displayed on the display component 508. The prompt 512 indicates “ANIMATE THE CAR.” In some embodiments, the prompt 512 is optional and/or the one or more content recommendations 516 can be generated without receiving or using the prompt 512. If the prompt 512 is not included, the computing device 500 can be configured to generate a plurality of content recommendations from which one or more can be selected by a user. The computing device can generate different versions of the content 510 that can be included in the content recommendation 516. For example, the different versions of the content 510 can include versions in which the automobile in the content 510 is maneuvering in different directions, travelling at different speeds, framed differently (e.g., cropped differently or captured from a different angle), and/or the background is different (e.g., an urban background or bucolic background).

The computing device 500 can determine one or more contexts based on content data associated with the content 510 and/or the prompt 512. For example, the computing device 500 can determine a user’s preferences based on the web pages that the user accessed. For example, if a user accesses more web pages with images of rural settings than web pages with images of other types of settings (e.g., urban settings), the computing device can determine that the user has a preference for environmental contexts that are rural in comparison to other types of environmental contexts.

The computing device 500 can use content data (e.g., content data associated with the content 510) and/or context data (e.g., context data associated with the content 510 and/or the prompt 512) as input to one or more machine-learned models that can be implemented on the computing device 500 and/or that are implemented on a remote computing device that is able to send data to and/or receive data from the computing device 500. The one or more machine-learned models can be configured and/or trained to recognize and/or classify one or more features of the content data, the context data, and/or the prompt 512. For example, the one or more machine-learned models can perform object detection operations, object recognition operations, and/or object classification operations to determine that the content 510 is an image of an automobile. Additionally, the one or more machine-learned models can perform image segmentation operations to determine the portions of the content 510 that are background, the portions of the content 510 that are foreground, and the portions of the content 510 comprising the automobile that comprise objects that can appear to move relative to other portions of the automobile (e.g., the wheels of the automobile can be modified to appear to be rotating).

Further, the one or more machine-learned models can recognize and/or classify one or more features of the prompt 512 and determine that the prompt 512 is a statement about the automobile and that the prompt 512 comprises a request to generate an animated version of the automobile in the content 510. The one or more machine-learned models can also use the context including the user’s preferred environmental contexts (e.g., a rural context). For example, the context can be used to determine whether the background is an urban or rural background based on the user’s website viewing history. The one or more machine-learned models can then use the content features, context features, and/or prompt features that were determined to generate modified content comprising a video segment of the automobile in the content 510 in a state of motion. The computing device 500 can then generate the one or more content recommendations 516 including the modified content based on the content 510 and comprising a video segment of the automobile from the content 510 in a state of motion.

Additionally, the interface element 518 which indicates “SHARE” can be used to send the one or more content recommendations 516 to one or more users. For example, the one or more content recommendations 516 including the video segment of an automobile in motion can be sent to one or more users via one or more applications comprising a social media application, a text message application, and/or an email application. Further, the one or more content recommendations 516 can be used to generate a link note that can be shared with one or more users, one or more user groups, and/or included in a web resource. The one or more content recommendations 516 can be shared based on the computing device 500 detecting a user touching the portion of the user interface that comprises the interface element 518.

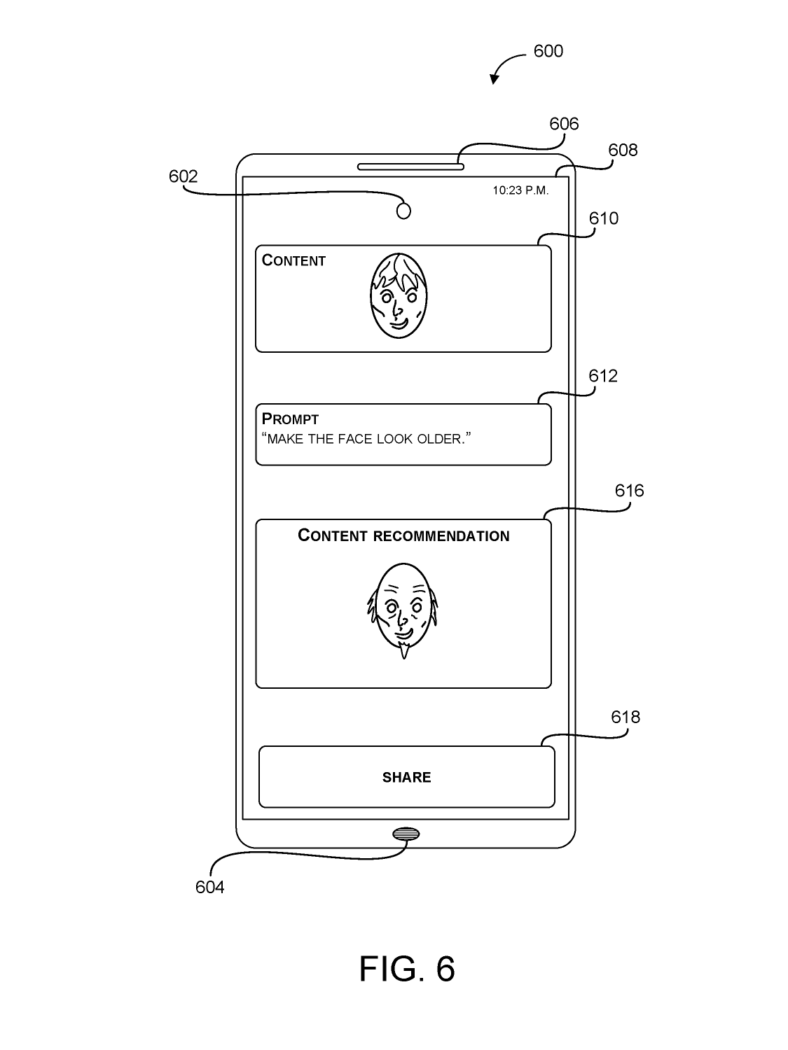

FIG. 6 depicts an example of modifying the appearance of a face in content according to example embodiments of the present disclosure. A computing device 600 can comprise one or more features and/or capabilities of the computing device 102, the server computing system 130, the training computing system 150, the computing device 300, and/or the computing device 500.

The computing device 600 can include an imaging component 602, an audio input component 604, an audio output component 606, a display component 608, content 610, a prompt 612, an indication 613, a content recommendation 614, a content recommendation 616, and/or interface element 618.

The computing device 600 can be configured to perform one or more operations comprising sending, receiving, processing, and/or generating data comprising content data (e.g., content data based on the content 610), context data, prompt data, and/or other data received by the computing device 600. In some embodiments, the imaging component can be used to generate the content 610 or capture an image of a user that may be used to verify the user’s identify and determine whether a user is authorized to perform one or more operations on the computing device 600 (e.g., sharing the one or more content recommendations 616). Further, the computing device 600 can be configured to generate the one or more content recommendations 616.

In this example, the computing device 600 has received the content 610, which comprises an image of a face, that is displayed on the display component 608. In some embodiments, the content 610 can comprise one or more audio segments (e.g., music or sound effects) that can accompany an image or video or be included without an accompanying image or video. Further, the computing device 600 has received the prompt 612, which is displayed on the display component 608. The prompt 612 indicates “MAKE THE FACE LOOK OLDER.” In some embodiments, the prompt 612 can be optional and the one or more content recommendations 616 can be generated without receiving or using the prompt 612. If the prompt 612 is not included, the computing device 600 can be configured to generate a plurality of content recommendations from which one or more can be selected by a user. The computing device can generate different versions of the content 610 that can be included in the content recommendation 616. For example, the different versions of the content 610 can include versions in which the face is various ages, has different facial hair, has more gray hair, has a different number of wrinkles, and/or is wearing glasses.

The computing device 600 can determine one or more contexts based on content data associated with the content 610 and/or the prompt 612. For example, the computing device 600 can determine that the content data associated with the content 610 comprises application data (e.g., application data from a camera application of the computing device 600 from which the content 610 captured). Further, the computing device 600 can use the application data to determine the types of modifications to the content 610. For example, if a user’s photo album comprises photographs in which the user has facial hair, the modified content can also have facial hair.

The computing device 600 can use content data (e.g., content data associated with the content 610) and/or context data (e.g., context data associated with the content 610 and/or the prompt 612) as input to one or more machine-learned models that can be implemented on the computing device 600 and/or that are implemented on a remote computing device that is able to send data to and/or receive data from the computing device 600. The one or more machine-learned models can be configured and/or trained to recognize and/or classify one or more features of the content data, the context data, and/or the prompt 612. For example, the one or more machine-learned models can perform object detection operations, object recognition operations, and/or object classification operations to determine that the content 610 is an image of a face.

Further, the one or more machine-learned models can recognize and/or classify one or more features of the prompt 612 and determine that the prompt 612 is a statement about the face and that the prompt 612 comprises a request to make the face appear older. The one or more machine-learned models can also use the context (e.g., the application data other images of the user) to determine user preferences based on the other image of the user. The one or more machine-learned models can then use the content features, context features, and/or prompt features that were determined to generate the one or more content recommendations 616 include modified content based on the content 610 and comprising an image and/or video of an older looking modified version of the face.

Additionally, the interface element 618 which indicates “SHARE” can be used to send the one or more content recommendations 616 including the image of a user whose appearance has been modified to appear older via one or more applications comprising a social media application, a text message application, and/or an email application. Further, the one or more content recommendations 616 can be used to generate a link note that can be shared with one or more users, one or more user groups, and/or included in a web resource. The one or more content recommendations 616 can be shared based on the computing device 600 detecting a user touching the portion of the user interface that comprises the interface element 618.

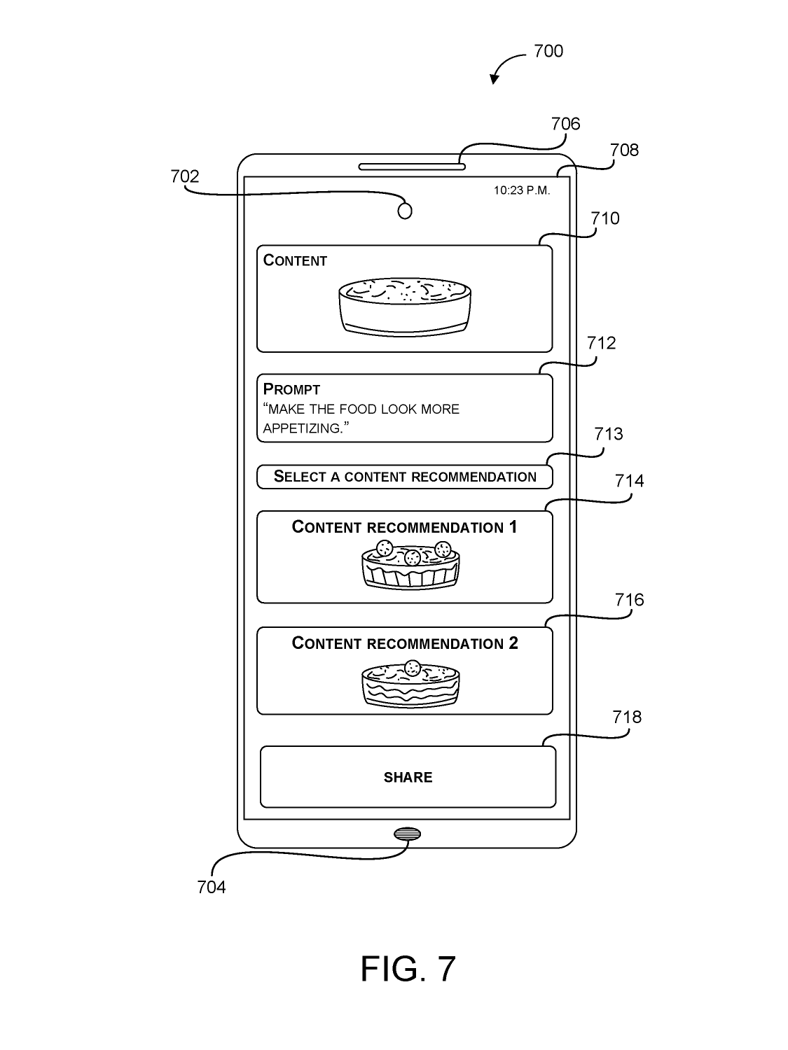

FIG. 7 depicts an example of modifying the appearance of an object in content according to example embodiments of the present disclosure. A computing device 700 can include one or more features and/or capabilities of the computing device 102, the server computing system 130, the training computing system 150, the computing device 300, and/or the computing device 500.

The computing device 700 can include an imaging component 702, an audio input component 704, an audio output component 706, a display component 708, content 710, a prompt 712, an indication 713, a content recommendation 714, a content recommendation 716, and/or interface element 718.

The computing device 700 can be configured to perform one or more operations comprising sending, receiving, processing, and/or generating data comprising content data (e.g., content data based on the content 710), context data, prompt data, and/or other data received by the computing device 700. In some embodiments, the imaging component can be used to generate the content 710 or capture an image of a user that may be used to verify the user’s identify and determine whether a user is authorized to perform one or more operations on the computing device 700 (e.g., sharing the one or more content recommendations 716). Further, the computing device 700 can be configured to generate the one or more content recommendations 716.

In this example, the computing device 700 has received the content 710, which comprises an image and/or video of a bowl of noodles, that is displayed on the display component 708. In some embodiments, the content 710 can comprise one or more audio segments (e.g., music or sound effects) that can accompany an image or video or be included without an accompanying image or video. Further, the computing device 700 has received the prompt 712, which is displayed on the display component 708. The prompt 712 indicates “MAKE THE FOOD LOOK MORE APPETIZING.” In some embodiments, the prompt 712 is optional and the content recommendation 714 and/or the content recommendation 716 can be generated without receiving or using the prompt 712. If the prompt 712 is not included, the computing device 700 can be configured to generate a plurality of content recommendations from which one or more can be selected by a user. The computing device can generate different versions of the content 710 that can be included in the content recommendation 716. For example, the different versions of the content 710 can include versions in which the bowl of noodles is larger or smaller, the noodles are covered with various sauces, the design or shape of the noodle bowl is different, and/or different types of food and/or utensils are included alongside the bowl of noodles.

The computing device 700 can determine one or more contexts based on content data associated with the content 710 and/or the prompt 712. For example, the computing device 700 can determine that the content data associated with the content 710 comprises application data (e.g., application data from a web browser that was used to browse a website and/or webpage from which the content 710 captured) indicating the website and/or webpage from which the image of the bowl of noodles was obtained. Further, the computing device 700 can use the application data to determine comments or ratings (e.g., a numerical rating or a thumbs up or thumbs down) with respect to other similar content. A user’s comments or preferences with respect to other content can be used to determine the types of modifications to the content 710. For example, if a user provides favorable feedback to noodles with a large amount of sauce, the modified content may comprise noodles with a large amount of sauce.

The computing device 700 can use content data (e.g., content data associated with the content 710) and/or context data (e.g., context data associated with the content 710 and/or the prompt 712) as input to one or more machine-learned models that can be implemented on the computing device 700 and/or that are implemented on a remote computing device that is able to send data to and/or receive data from the computing device 700. The one or more machine-learned models can be configured and/or trained to recognize and/or classify one or more features of the content data, the context data, and/or the prompt 712. For example, the one or more machine-learned models can perform object detection operations, object recognition operations, and/or object classification operations to determine that the content 710 is an image of a bowl of noodles which is classified as food. Additionally, the one or more machine-learned models can perform image segmentation operations to determine the portions of the content 710 that comprise the bowl and the portions of the content 710 that comprise the noodles.

Further, the one or more machine-learned models can recognize and/or classify one or more features of the prompt 712 and determine that the prompt 712 is a statement about the bowl of noodles and that the prompt 712 comprises a request to make the bowl of noodles appear more appetizing. The one or more machine-learned models can also use the context (e.g., user reviews from food websites and/or other images of food which can include noodles that are included in the user’s photo album) to determine a user’s preferences with respect to food. The one or more machine-learned models can then use the content features, context features, and/or prompt features that were determined to generate the content recommendation 714 and the content recommendation 716. The content recommendation 714 can include modified content based on the content 710 and comprising an image and/or video of the bowl of noodles with three croquettes and a different bowl design than the bowl in the content 710 or the content recommendation 716. The content recommendation 716 can include modified content based on the content 710 and comprising an image and/or video of the bowl of noodles with one croquette and a different bowl design than the bowl in the content 710 or the content recommendation 714. The indication 713 indicates “SELECT A CONTENT RECOMMENDATION.” A user can select either the content recommendation 714 or the content recommendation 716. For example, the content recommendation 714 and/or the content recommendation 716 can be interface elements that are configured to detect a tactile input (e.g., a touch) that indicates selection of a content recommendation.

Additionally, the interface element 718 which indicates “SHARE” can be used to send the content recommendation 714 or the content recommendation 716 to other users. For example, the content recommendation 714 or the content recommendation 716 can be shared with other users via one or more applications comprising a social media application, a text message application, and/or an email application. Further, the content recommendation 714 or the content recommendation 716 can be used to generate a link note that can be shared with one or more users, one or more user groups, and/or included in a web resource. The content recommendation 714 or the content recommendation 716 can be shared based on the computing device 700 detecting a user touching the portion of the user interface that comprises the interface element 718.

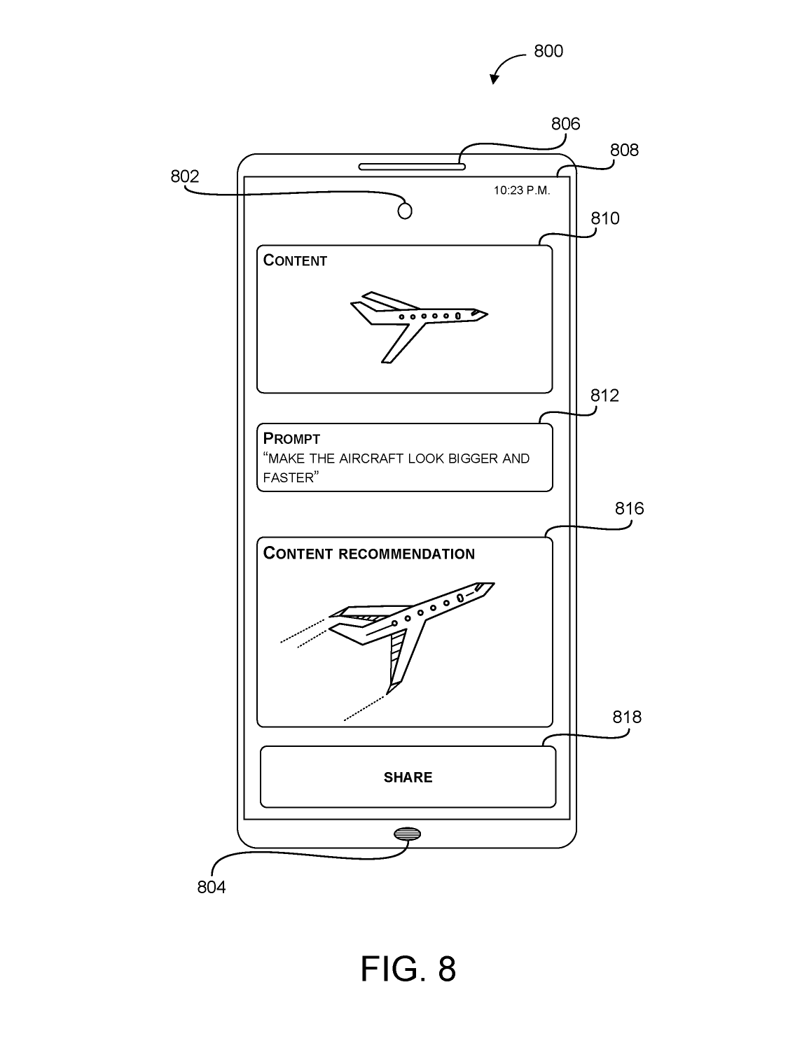

FIG. 8 depicts an example of modifying the size and appearance of an object in content according to example embodiments of the present disclosure. A computing device 800 can include one or more features and/or capabilities of the computing device 102, the server computing system 130, the training computing system 150, the computing device 300, and/or the computing device 500.

The computing device 800 can include an imaging component 802, an audio input component 804, an audio output component 806, a display component 808, content 810, a prompt 812, one or more content recommendations 816, and/or interface element 818.

The computing device 800 can be configured to perform one or more operations comprising sending, receiving, processing, and/or generating data comprising content data (e.g., content data based on the content 810), context data, prompt data, and/or other data received by the computing device 800. In some embodiments, the imaging component can be used to generate the content 810 or capture an image of a user that may be used to verify the user’s identify and determine whether a user is authorized to perform one or more operations on the computing device 800 (e.g., sharing the one or more content recommendations 816). Further, the computing device 800 can be configured to generate the one or more content recommendations 816.

In this example, the computing device 800 has received the content 810, which comprises an image and/or video of an aircraft, that is displayed on the display component 808. In some embodiments, the content 810 can comprise one or more audio segments (e.g., music or sound effects) that can accompany an image or video or be included without an accompanying image or video. Further, the computing device 800 has received the prompt 812, which is displayed on the display component 808. The prompt 812 indicates “MAKE THE AIRCRAFT LOOK BIGGER AND FASTER.” In some embodiments, the prompt 812 is optional and/or the one or more content recommendations 816 can be generated without receiving or using the prompt 812. If the prompt 812 is not included, the computing device 800 can be configured to generate a plurality of content recommendations from which one or more can be selected by a user. The computing device can generate different versions of the content 810 that can be included in the content recommendation 816. For example, the different versions of the content 810 can include versions in which the aircraft in the content 810 has longer wings, the aircraft in the content 810 has additional engines, the aircraft in the content 810 is framed differently (e.g., cropped differently), and/or the background is different (e.g., a night sky).

The computing device 800 can determine one or more contexts based on content data associated with the content 810 and/or the prompt 812. For example, the computing device 800 can determine that the content data associated with the content 810 comprises application data (e.g., application data from a web browser that was used to browse a website and/or webpage from which the content 810 captured) indicating the website and/or webpage from which the image of the city skyline was obtained. Further, the computing device 800 can use the application data to determine that the user had recently viewed web pages with images of high-speed jet aircrafts and rocket powered aircraft. A user’s browser history can be used to determine the types of modifications to the content 810. For example, the image of the aircraft may be modified to include visual features of high-speed jet aircraft and/or rocket powered aircraft.

The computing device 800 can use content data (e.g., content data associated with the content 810), prompt 812, and/or context data (e.g., context data associated with the content 810 and/or the prompt 812) as input to one or more machine-learned models that can be implemented on the computing device 800 and/or that are implemented on a remote computing device that is able to send data to and/or receive data from the computing device 800. The one or more machine-learned models can be configured and/or trained to recognize and/or classify one or more features of the content data, the context data, and/or the prompt 812. For example, the one or more machine-learned models can perform object detection operations, object recognition operations, and/or object classification operations to determine that the content 810 is an image of an aircraft.

Further, the one or more machine-learned models can recognize and/or classify one or more features of the prompt 812 and determine that the prompt 812 is a statement about the aircraft and that the prompt 812 comprises a request to generate modified content in which the aircraft appears bigger and faster. The one or more machine-learned models can also use the context (e.g., the application data indicating the website and/or webpage including images of high-speed jet aircraft and rocket powered aircraft) to modify the appearance of the aircraft in the content 810. The one or more machine-learned models can then use the content features, context features, and/or prompt features that were determined to generate the one or more content recommendations 816 include modified content based on the content 810 and comprising an image and/or video of the aircraft that is larger than the aircraft in content 810, tilted at an upward angle, comprising visual modifications to the appearance of the aircraft (e.g., modified wings and a stripe through the hull section of the aircraft), and air trails behind the wings and tail of the aircraft.

Additionally, the interface element 818 which indicates “SHARE” can be used to send the one or more content recommendations 816 including the image or video segment of a bigger and faster looking aircraft via one or more applications comprising a social media application, a text message application, and/or an email application. Further, the one or more content recommendations 816 can be used to generate a link note that can be shared with one or more users, one or more user groups, and/or included in a web resource. The one or more content recommendations 816 can be shared based on the computing device 800 detecting a user touching the portion of the user interface that comprises the interface element 818.

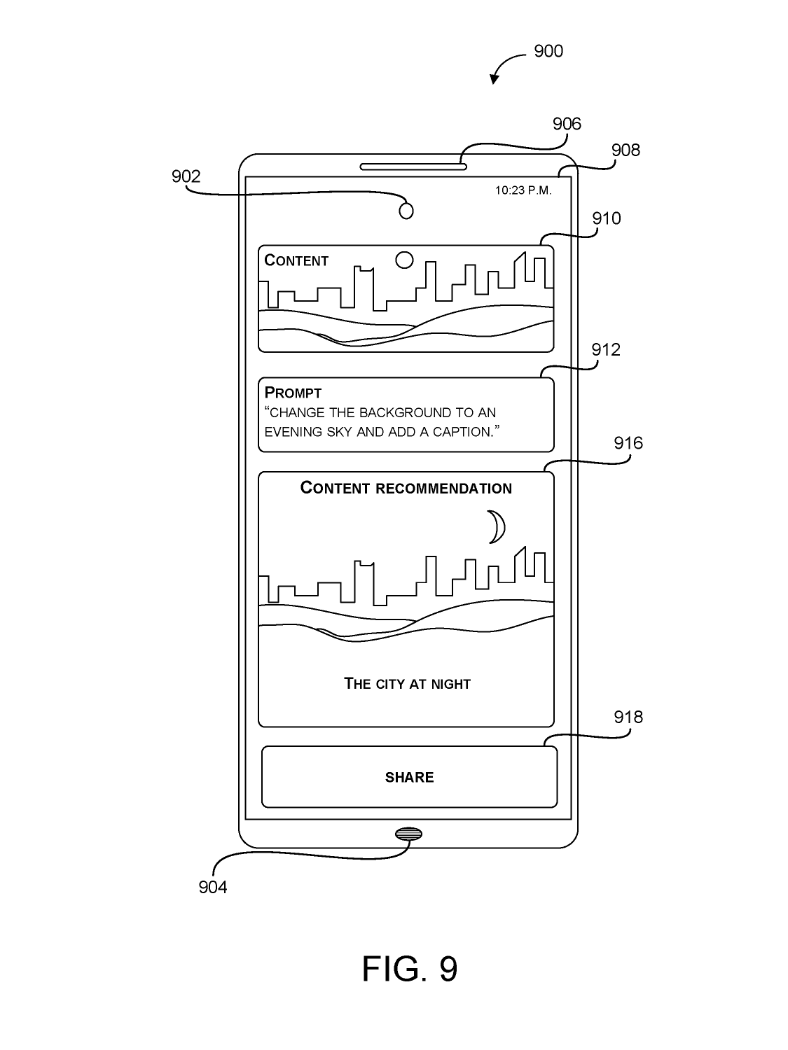

FIG. 9 depicts an example of modifying a background of content according to example embodiments of the present disclosure. A computing device 900 can include one or more features and/or capabilities of the computing device 102, the server computing system 130, the training computing system 150, the computing device 300, and/or the computing device 500.

The computing device 900 can include an imaging component 902, an audio input component 904, an audio output component 906, a display component 908, content 910, a prompt 912, one or more content recommendations 916, and/or interface element 918.

The computing device 900 can be configured to perform one or more operations comprising sending, receiving, processing, and/or generating data comprising content data (e.g., content data based on the content 910), context data, prompt data, and/or other data received by the computing device 900. In some embodiments, the imaging component can be used to generate the content 910 or capture an image of a user that may be used to verify the user’s identify and determine whether a user is authorized to perform one or more operations on the computing device 900 (e.g., sharing the one or more content recommendations 916). Further, the computing device 900 can be configured to generate the one or more content recommendations 916.

In this example, the computing device 900 has received the content 910, which comprises an image and/or video of a city skyline during the day with the sun in the sky, that is displayed on the display component 908. In some embodiments, the content 910 can comprise one or more audio segments (e.g., music or sound effects) that can accompany an image or video or be included without an accompanying image or video. Further, the computing device 900 has received the prompt 912, which is displayed on the display component 908. The prompt 912 indicates “CHANGE THE BACKGROUND TO AN EVENING SKY AND ADD A CAPTION.” In some embodiments, the prompt 912 is optional and/or the one or more content recommendations 916 can be generated without receiving or using the prompt 912. If the prompt 912 is not included, the computing device 900 can be configured to generate a plurality of content recommendations from which one or more can be selected by a user. The computing device can generate different versions of the content 910 that can be included in the content recommendation 916. For example, the different versions of the content 910 can include versions in which the buildings in the content 910 are taller, smaller, framed differently (e.g., cropped differently or captured from a different angle), and/or the background is different (e.g., different times of day, raining, a different numbers of clouds in the sky).

The computing device 900 can determine one or more contexts based on content data associated with the content 910 and/or the prompt 912. For example, the computing device 900 can determine that the content data associated with the content 910 comprises application data (e.g., application data from a web browser that was used to browse a website and/or webpage from which the content 910 captured) indicating the website and/or webpage from which the image of the city skyline was obtained. Further, the computing device 900 can use the application data to determine comments or ratings (e.g., a numerical rating or a thumbs up or thumbs down) with respect to other similar content. A user’s comments or preferences with respect to other content can be used to determine the types of modifications to the content 910. For example, if a user provides favorable feedback to wintery scenes, the modified content may comprise snow.

The computing device 900 can use content data (e.g., content data associated with the content 910) and/or context data (e.g., context data associated with the content 910 and/or the prompt 912) as input to one or more machine-learned models that can be implemented on the computing device 900 and/or that are implemented on a remote computing device that is able to send data to and/or receive data from the computing device 900. The one or more machine-learned models can be configured and/or trained to recognize and/or classify one or more features of the content data, the context data, and/or the prompt 912. For example, the one or more machine-learned models can perform object detection operations, object recognition operations, and/or object classification operations to determine that the content 910 is an image of a city skyline. Additionally, the one or more machine-learned models can perform image segmentation operations to determine the portions of the content 910 that are background or foreground.

Further, the one or more machine-learned models can recognize and/or classify one or more features of the prompt 912 and determine that the prompt 912 is a statement about the skyline and that the prompt 912 comprises a request to generate a caption based on the modified content. The one or more machine-learned models can also use the context (e.g., the application data indicating the website and/or webpage from which the image of the city skyline was obtained) to determine user preferences based on comments and/or ratings provided by the user in one or more websites. The one or more machine-learned models can then use the content features, context features, and/or prompt features that were determined to generate the one or more content recommendations 916 include modified content based on the content 910 and comprising an image and/or video of the city skyline at night with the moon in the sky and a caption indicating “THE CITY AT NIGHT.”

Additionally, the interface element 918 which indicates “SHARE” can be used to send the one or more content recommendations 916 comprising the image of the city at night via one or more applications comprising a social media application, a text message application, and/or an email application. Further, the one or more content recommendations 916 can be used to generate a link note that can be shared with one or more users, one or more user groups, and/or included in a web resource. The one or more content recommendations 916 can be shared based on the computing device 900 detecting a user touching the portion of the user interface that comprises the interface element 918.

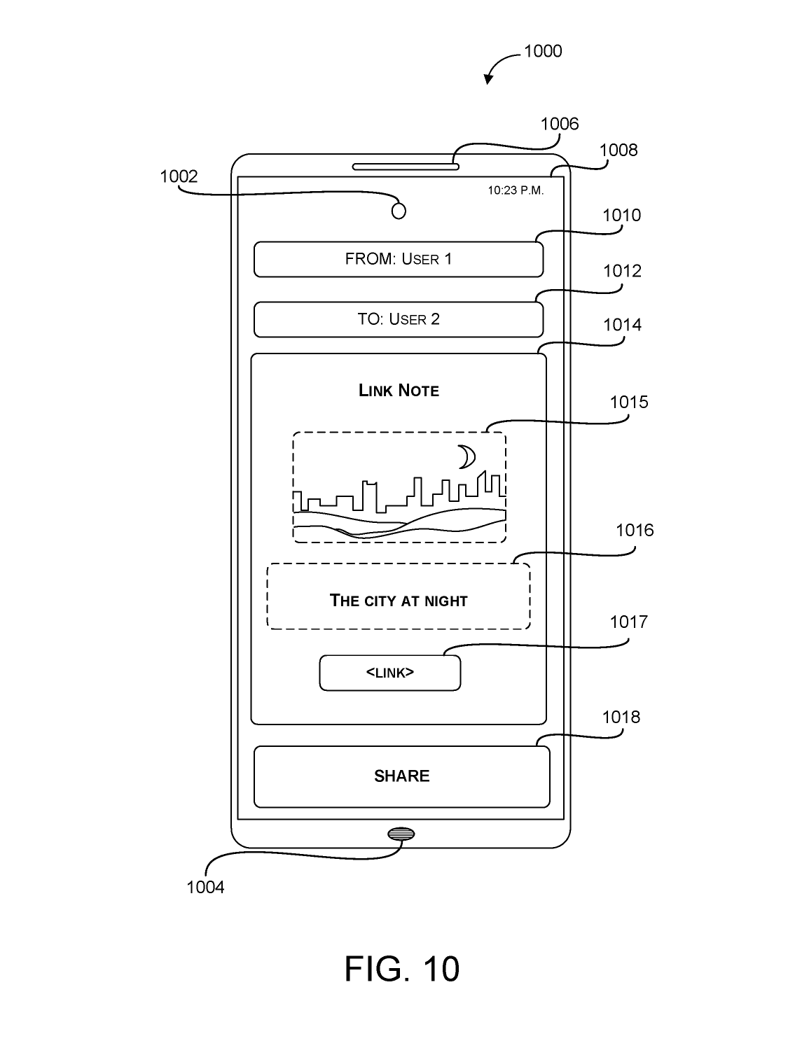

FIG. 10 depicts an example of a link note based on one or more content recommendations according to example embodiments of the present disclosure. A computing device 1000 can include one or more features and/or capabilities of the computing device 102, the server computing system 130, the training computing system 150, the computing device 300, and/or the computing device 500.

The computing device 1000 can include an imaging component 1002, an audio input component 1004, an audio output component 1006, a display component 1008, sender indication 1010, a receiver indication 1012, a link note 1014, modified content 1015, modified content caption 1016, link 1017, and/or interface element 1018.

The computing device 1000 can be configured to perform one or more operations comprising sending, receiving, processing, and/or generating data comprising link note data (e.g., link note data based on the link note 1014), content data, context data, prompt data, and/or other data received by the computing device 1000. Further, the computing device 1000 can be configured to generate the link note 1014.

In this example, the computing device 1000 has generated and/or accessed the link note 1014 which comprises content 1015 (e.g., an image of a city skyline at night), the modified content caption 1016 which indicates “THE CITY AT NIGHT” and a link 1017 that indicates “<LINK>” and comprises a link to a web resource (e.g., a social media posting from which the content 1015 was obtained) displayed on the display component 1008. In some embodiments, the computing device 1000 can generate and/or access the link note 1014 based on one or more interactions by the user with an interface element (e.g., the interface element 918 that is described with respect to FIG. 9). Further, the computing device 1000 has generated the sender indication 1010 which indicates “FROM: USER 1” and can be used to indicate the user that is sending the link note 1014. The computing device 1000 has also generated the receiver indication 1012 which indicates “TO: USER 2” and can be used to indicate the user that may receive the link note 1014.

Additionally, the interface element 1018 which indicates “SHARE” can be used to send the link note 1014 to one or more users (e.g., “USER 2” indicated in the receiver indication 1012). For example, the link note 1014 can be shared based on the computing device 1000 detecting a user touching the portion of the user interface that comprises the interface element 1018. In some embodiments, the link note 1014 can be included in one or more web resources. For example, the link note 1014 can be included in a search result for skyline images or the city captured in the modified content 1015, a social media post, and/or a review website.

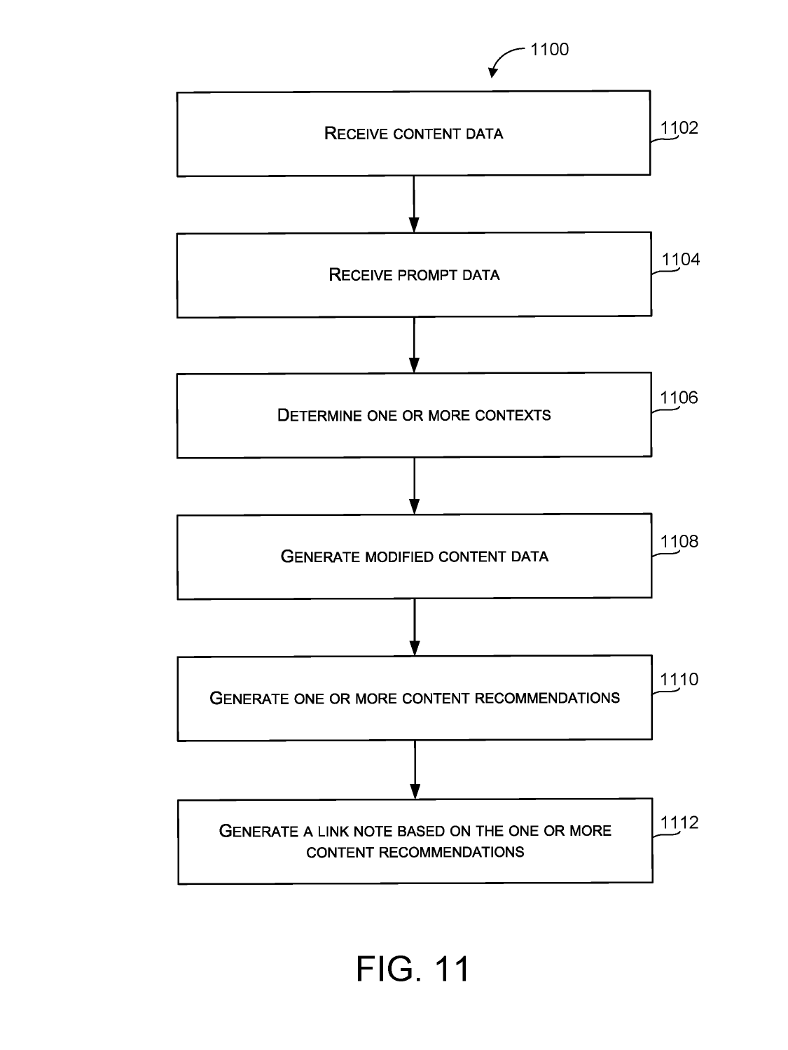

FIG. 11 depicts a flow chart diagram of an example method of generating modified content data according to example embodiments of the present disclosure. One or more portions of the method 1100 can be executed and/or implemented on one or more computing devices or computing systems comprising, for example, the computing device 102, the server computing system 130, the training computing system 150, and/or the computing device 300. Further, one or more portions of the method 1100 can be executed or implemented as an algorithm on the hardware devices or systems disclosed herein. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include receiving content data comprising content associated with one or more data modalities. For example, the computing device 102 can receive content data comprising an image of a user’s face. The content data can be received from a local device (e.g., an image captured by the computing device 102) and/or from a remote source (e.g., a remote computing system) via a network such as the network 180.

At 1104, the method 1100 can include receiving one or more prompts associated with modification of the content data. For example, the one or more prompts can comprise a prompt to modify the appearance of content comprising an image of a face. Further, the computing device 102 can receive data (e.g., prompt data) comprising one or more text-based prompts from an input device (e.g., keyboard) of the computing device 102. The prompt data can be received from a local device and/or from a remote source (e.g., a remote computing system) via a network such as the network 180.

At 1106, the method 1100 can include determining one or more contexts associated with the content data. For example, the server computing system 130 can access the application data of an image management application of a user to determine context comprising images that a user stores in an image repository of the image management application.

At 1108, the method 1100 can include generating and/or determining, based on inputting the content data, the one or more prompts, and context data based on the one or more contexts into one or more machine-learned models, modified content data. The modified content data can be based on the content data, the context data, and/or the one or more prompts. The machine-learned model can be configured and/or trained to generate the modified content data based on detection, recognition, and/or classification of one or more features of the content data and the context data. Further, the one or more machine-learned models can be configured and/or trained to modify the one or more features of the content data based on the one or more prompts and the context data. For example, the server computing system 130 can implement one or more machine-learned models that are configured and/or trained to generate modified content data (e.g., a modified image of a house in which the house is larger and more luxurious than the actual house depicted in the content data) based on input comprising an image, a prompt to modify the image, and context associated with an event (e.g., high-school graduation) associated with the image.

At 1110, the method 1100 can include one or more content recommendations based on the modified content data. For example, the computing device 102 can generate one or more content recommendations comprising one or more different versions of modified content data which can include different versions of an image of a face (e.g., an older version of a face, a younger version of a face, a version of a face with longer hair or shorter hair, and/or a version of the face wearing a hat and/or glasses).

At 1112, the method 1100 can include generating a link note based on the one or more content recommendations. For example, the server computing system 130 can generate a link note comprising the one or more content recommendations and a link (e.g., a hyperlink) to a publicly shared content repository (e.g., an online photo album) that comprises other content associated with the modified content data.

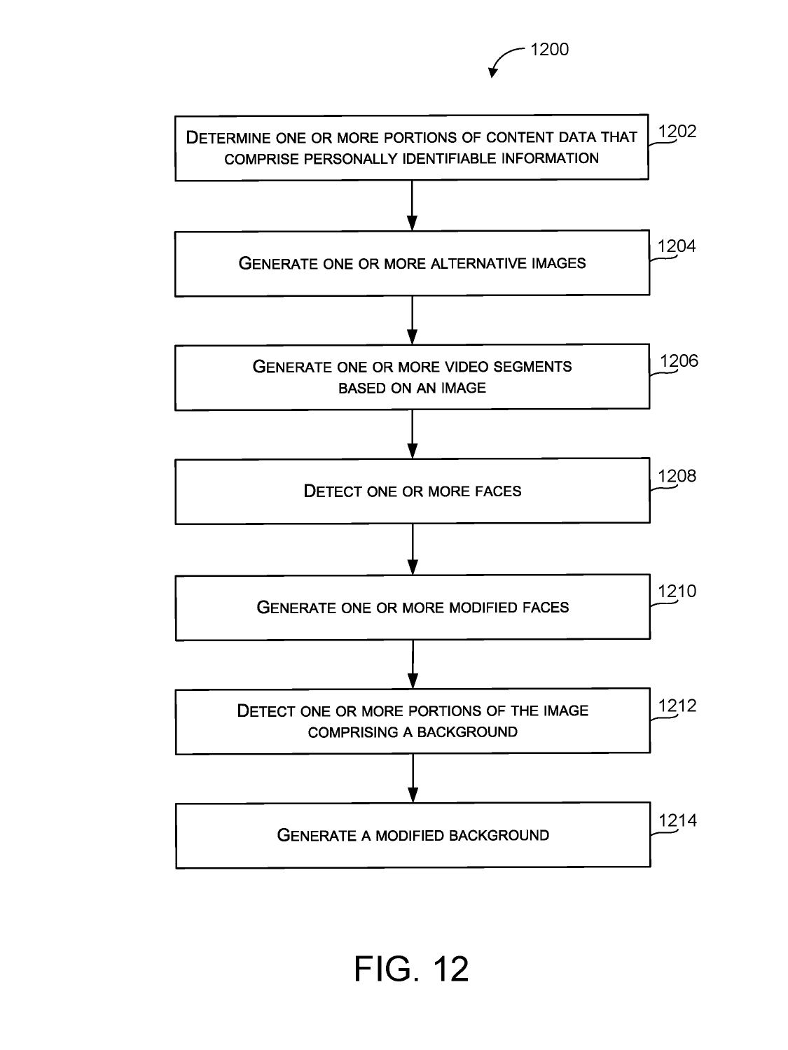

FIG. 12 depicts a flow chart diagram of an example method of generating modified content data according to example embodiments of the present disclosure. One or more portions of the method 1200 can be executed and/or implemented on one or more computing devices or computing systems comprising, for example, the computing device 102, the server computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 1100 that is described with respect to FIG. 11. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include determining one or more portions of the content data that comprise personally identifiable information. For example, the server computing system 130 can perform one or more object recognition operations on content data comprising an image in order to detect personally identifiable information (e.g., vehicle license plates) in the image.

At 1204, the method 1200 can include generating one or more alternative images in the one or more portions of the content data that comprise the personally identifiable information. The one or more alternative images can conceal the personally identifiable information. For example, if the content data comprises image content the server computing system 130 can generate a blurred version of the content that obscures or conceals the content in the one or more portions of the image content that were determined to comprise personally identifiable information.

At 1206, the method 1200 can include generating modified content data comprising one or more video segments based on the image. For example, the server computing system 130 can implement one or more machine-learned models that are configured and/or trained to perform object detection operations, object recognition operations, and/or object classification operations and determine one or more segments of an image that comprise objects that have a higher probability of moving (e.g., a squirrel or a motorcycle can have a higher probability of moving than a lamppost or tree). The one or more machine-learned models implemented by the server computing system 130 can then generate one or more video segments based on the image. For example, a video segment of a squirrel climbing a tree can be generated based on an image of the squirrel sitting next to the tree.

At 1208, the method 1200 can include detecting one or more faces in one or more portions of the image. For example, the server computing system 130 can implement one or more machine-learned models that are configured and/or trained to perform object detection operations, object recognition operations, and/or object classification operations on content data comprising an image in order to detect, recognize, and/or classify one or more faces in the image.

At 1210, the method 1200 can include generating one or more modified faces in the one or more portions of the image in which the modified content data comprises the one or more faces. For example, the server computing system 130 can implement one or more machine-learned models that are configured and/or trained to generate modified content data (e.g., a modified image of face such that the face appears older or more attractive) based on input comprising content comprising an image of the face, a prompt to modify the content comprising the image of the face, and context associated with the content comprising the image of the face (e.g., an image of the face wearing makeup, glasses, colored contact lenses, and/or jewelry).

At 1212, the method 1200 can include detecting one or more portions of the image comprising a background. For example, the server computing system 130 can implement one or more machine-learned models that are configured and/or trained to perform one or more image segmentation operations on content data comprising an image and/or video in order to detect one or more portions of the image and/or video that comprise a foreground and/or background.

At 1214, the method 1200 can include generating a modified background in the one or more portions of the image comprising the background. The modified content data can comprise the modified background. For example, the server computing system 130 can implement one or more machine-learned models that are configured and/or trained to generate modified content data (e.g., a background) in one or more portions of an image that are determined to be a background of the image. For example, a nighttime background can be modified to a daytime background or a background with buildings and not trees can be modified to a background with a large forest.

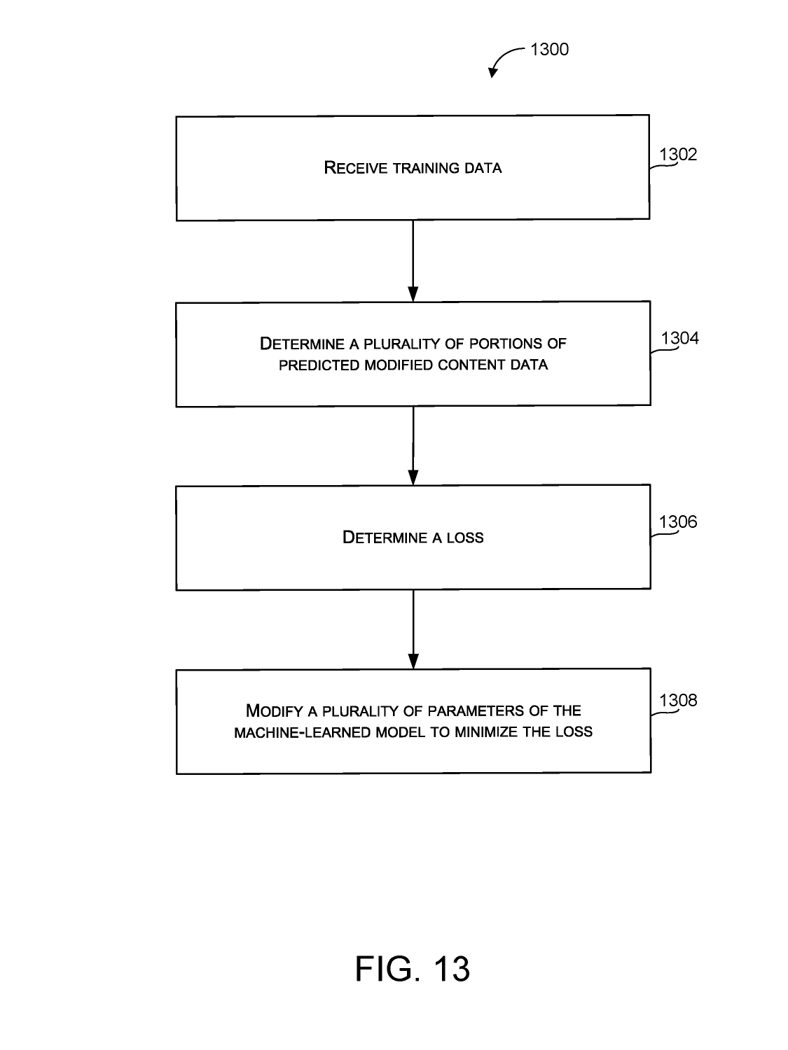

FIG. 13 depicts a flow chart diagram of an example method of training machine-learned models to generate modified content data according to example embodiments of the present disclosure. One or more portions of the method 1300 can be executed and/or implemented on one or more computing devices or computing systems comprising, for example, the computing device 102, the server computing system 130, the training computing system 150, and/or the computing device 300. Further, one or more portions of the method 1300 can be executed or implemented as an algorithm on the hardware devices or systems disclosed herein. In some embodiments, one or more portions of the method 1300 can be performed as part of the method 1100 that is described with respect to FIG. 11. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include receiving training data comprising a plurality of training content inputs and a corresponding plurality of ground-truth modified content data. For example, the server computing system 130 can receive training data comprising a plurality of training data inputs. The plurality of training data inputs can comprise a plurality of training images, a plurality of training audio segments, a plurality of training text segments, a plurality of multimodal training segments, a plurality of training video segments, a plurality of training contexts, and/or a plurality of training prompts. For example, the plurality of training data inputs can comprise a plurality of training images of a plurality of different faces, prompts to modify the plurality of different faces, a plurality of training contexts associated with the plurality of training images, and a plurality of ground-truth modified content data that can comprise images of the modified faces (e.g., faces that have been modified to look older or more attractive).

At 1304, the method 1300 can include determining, based on inputting the plurality of training data inputs into the machine-learned model, a plurality of portions of predicted modified content data. For example, the server computing system 130 can implement a machine-learned model. Further, based on inputting the plurality of training data inputs into the machine-learned model, the machine-learned model can perform one or more operations (e.g., detection, recognition, and/or classification operations) on the plurality of training data inputs and generate an output comprising a plurality of portions of predicted modified content data.

At 1306, the method 1300 can include determining a loss based on one or more differences between the plurality of portions of predicted modified content data and the plurality of portions of ground-truth modified content data. For example, over a plurality of iterations, the server computing system 130 can determine a loss (e.g., a cross-entropy loss) based on one or more differences between the plurality of portions of predicted modified content data and the plurality of portions of ground-truth modified content data. The one or more differences between the plurality of portions of predicted modified content data and the plurality of portions of ground-truth modified content data can be based on one or more comparisons of the plurality of portions of predicted modified content data to the plurality of portions of ground-truth modified content data.

At 1308, the method 1300 can include modifying a plurality of parameters of the machine-learned model to minimize the loss. For example, the server computing system 130 can modify a plurality of weights of the plurality of parameters so that the weights of the plurality of parameters that contribute to reducing the loss (e.g., the parameters that increase the accuracy of the machine-learned model generating a plurality of portions of predicted modified content data that are accurate) are increased and/or the weights of the plurality of parameters that contribute to increasing the loss (e.g., the parameters that decrease the accuracy of the machine-learned model generating a plurality of portions of predicted modified content data that are accurate) are decreased. The plurality of weights of the plurality of parameters can be modified until some threshold loss (e.g., a minimized loss) that corresponds to a high accuracy of the plurality of predicted modified content data is exceeded.

Further to the descriptions above, a user may be provided with controls allowing the user to make an election as to both if and/or when systems, programs, or features described herein may enable collection of user information (e.g., image information), and if the user is sent content or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating modified content, the computer-implemented method comprising:
receiving, by a computing system comprising one or more processors, content data comprising content associated with one or more data multimodalities;
receiving, by the computing system, prompt data comprising one or more prompts associated with modification of the content data;
determining, by the computing system, one or more contexts associated with the content data;
generating, by the computing system, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data; and
generating, by the computing system, one or more content recommendations based on the modified content data.

2. The computer-implemented method of claim 1, wherein the generating, by the computing system, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data comprises:
determining, by the computing system, one or more portions of the content data that comprise personally identifiable information; and
generating, by the computing system, one or more alternative images in the one or more portions of the content data that comprise the personally identifiable information, wherein the one or more alternative images conceal the personally identifiable information.

3. The computer-implemented method of claim 2, wherein the personally identifiable information comprises one or more names, one or more addresses, one or more street addresses, or one or more vehicle license plate numbers.

4. The computer-implemented method of claim 1, wherein the content data comprises an image, and wherein the generating, by the computing system, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data comprises:
generating, by the computing system, one or more video segments based on the image, wherein the modified content data comprises the one or more video segments.

5. The computer-implemented method of claim 1, wherein the content comprises an image, and wherein the generating, by the computing system, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data comprises:
detecting, by the computing system, one or more faces in one or more portions of the image; and
generating, by the computing system, one or more modified faces in the one or more portions of the image in which the modified content data comprises the one or more faces.

6. The computer-implemented method of claim 5, wherein the one or more modified faces are based on one or more modifications of one or more facial expressions of at least one face of the one or more faces or one or more modifications of an apparent age of at least one face of the one or more faces.

7. The computer-implemented method of claim 1, wherein the content comprises an image, and wherein the generating, by the computing system, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data comprises:
detecting, by the computing system, one or more portions of the image comprising a background; and
generating, by the computing system, a modified background in the one or more portions of the image comprising the background, wherein the modified content data comprises the modified background.

8. The computer-implemented method of claim 1, wherein the modified content data comprises a plurality of different versions of the content comprising one or more different modifications of the one or more features of the content data, and wherein the one or more content recommendations are based on the plurality of different versions of the content.

9. The computer-implemented method of claim 1, further comprising:
generating, by the computing system, a link note comprising the modified content data and one or more links to one or more web resources associated with the modified content data, wherein the one or more web resources comprise one or more search results, one or more web pages, one or more database entries, or one or more social media posts.

10. The computer-implemented method of claim 1, wherein the content data comprises one or more images, one or more text segments, one or more audio segments, or one or more video segments.

11. The computer-implemented method of claim 1, wherein the content data comprises an image, wherein the one or more prompts comprise one or more selections indicating one or more portions of the image to modify, and wherein the one or more modifications of the one or more features of the content data comprise one or more modifications of the one or more portions of the image indicated in the one or more selections.

12. The computer-implemented method of claim 1, wherein the one or more machine-learned models comprise one or more multimodal transformer models that are trained to generate the modified content data based on training data comprising training content, a plurality of training prompts, and a plurality of training contexts, and wherein the training content comprises a plurality of training images, a plurality of training text segments, a plurality of training audio segments, and a plurality of training video segments.

13. The computer-implemented method of claim 1, wherein the one or more machine-learned models are trained to generate the modified content data, and wherein the training of the one or more machine-learned models comprises:
receiving, by the computing system, training data comprising a plurality of training data inputs, a plurality of training prompts, and a corresponding plurality of portions of ground-truth modified content data;
determining, by the computing system, based on inputting the plurality of training data inputs into the one or more machine-learned models, a plurality of portions of predicted modified content data;
determining, by the computing system, a loss based on one or more differences between the plurality of portions of predicted modified content data and the corresponding plurality of portions of ground-truth modified content data; and
modifying, by the computing system, a plurality of parameters of the one or more machine-learned models to minimize the loss.

14. The computer-implemented method of claim 1, wherein the content comprises an image, wherein the one or more machine-learned models are configured to detect one or more objects in the image, and wherein the one or more modifications comprise modification of a size of at least one object of the one or more objects in the image, removal of at least one object of the one or more objects in the image, or addition of at least one object to the one or more objects in the image.

15. The computer-implemented method of claim 1, wherein the content comprises a video segment, wherein the one or more machine-learned models are configured to detect one or more objects in the video segment, and wherein the one or more modifications comprise modification of a size of at least one object of the one or more objects in the video segment, removal of at least one object of the one or more objects in the video segment, or addition of at least one object to the one or more objects in the video segment.

16. One or more tangible non-transitory computer-readable media storing computer-readable instructions that when executed by one or more processors cause the one or more processors to perform operations, the operations comprising:
receiving content data comprising content associated with one or more data multimodalities;
receiving prompt data comprising one or more prompts associated with modification of the content data;
determining one or more contexts associated with the content data;
generating, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data; and
generating one or more content recommendations based on the modified content data.

17. The one or more tangible non-transitory computer-readable media of claim 16, wherein the one or more machine-learned models comprise one or more multimodal transformer models that are trained to generate the modified content data based on training data comprising training content, a plurality of training prompts, and a plurality of training contexts, and wherein the training content comprises a plurality of training images, a plurality of training text segments, a plurality of training audio segments, and a plurality of training video segments.

18. A computing system comprising:
one or more processors;
one or more non-transitory computer-readable media storing instructions that when executed by the one or more processors cause the one or more processors to perform operations comprising:
receiving content data comprising content associated with one or more data multimodalities;
receiving prompt data comprising one or more prompts associated with modification of the content data;
determining one or more contexts associated with the content data;
generating, based on inputting the content data, the prompt data, and context data based on the one or more contexts into one or more machine-learned models, modified content data based on the content data and comprising one or more modifications of one or more features of the content data, wherein the one or more machine-learned models are configured to modify the one or more features of the content data based on the one or more prompts and the context data; and
generating one or more content recommendations based on the modified content data.

19. The computing system of claim 18, wherein the content comprises one or more images, and wherein the one or more modifications comprise modification of a size of one or more portions of the one or more images, modification of one or more backgrounds of the one or more images, removal of one or more features of the one or more images, or addition of one or more features to the one or more images.

20. The computing system of claim 18, wherein the one or more machine-learned models comprise one or more multimodal transformer models that are trained to generate the modified content data based on training data comprising training content, a plurality of training prompts, and a plurality of training contexts, and wherein the training content comprises a plurality of training images, a plurality of training text segments, a plurality of training audio segments, and a plurality of training video segments.
